(19) United States
(12) Patent Application Publication
(10) Pub. No.: US 2018/0255160 A1
(43) Pub. Date: Sep. 6, 2018

(54) COMPUTERIZED ACCOUNTING INFORMATION SYSTEM AND A METHOD OF PROCESSING ACCOUNTING DATA

(71) Applicant: Daniel A. Dooley, Hull, GA (US)

(72) Inventor: Daniel A. Dooley, Hull, GA (US)

(21) Appl. No.: 15/859,926

(22) Filed: Jan. 2, 2018

Related U.S. Application Data
(63) Continuation-in-part of application No. 14/593,438, filed on Jan. 9, 2015, now abandoned.
Application No. 14/593,438 is a continuation-in-part of application No. 13/560,528, filed on Jul. 27, 2012, now Pat. No. 9,378,026.
Application No. 13/560,528 is a continuation-in-part of application No. 15/371,169, filed on Dec. 6, 2016.
Application No. 15/371,169 is a continuation-in-part of application No. 13/874,476, filed on Apr. 30, 2013, now Pat. No. 9,544,284.
Application No. 13/874,476 is a continuation-in-part of application No. 13/560,528, filed on Jul. 27, 2012, now Pat. No. 9,378,026.
Application No. 15/371,169 is a continuation-in-part of application No. 14/593,438, filed on Jan. 9, 2015, now abandoned.
Application No. 14/593,438 is a continuation-in-part of application No. 13/560,528, filed on Jul. 27, 2012, now Pat. No. 9,378,026.
Application No. 15/371,169 is a continuation-in-part of application No. 15/164,346, filed on May 25, 2016, now abandoned.
Application No. 15/164,346 is a continuation of application No. 13/560,528, filed on Jul. 27, 2012, now Pat. No. 9,378,026.

(51) Int. Cl. H04L 29/06; H04L 29/08; G06F 8/30; G06F 8/61; G06F 8/65; G06F 9/4401

(52) U.S. Cl. CPC H04L 67/42; H04L 67/02; G06F 8/30; G06F 9/4411; G06F 8/65; H04L 67/34; G06F 8/61

(57) ABSTRACT

The present disclosure describes various embodiments, as well as features and aspects thereof, of a computerized accounting information system that avoid using spreadsheets, having to set up the same entity in various unique “sets of books”, and having to deal with the implications of tracking various accounting objectives. Instead, the computerized accounting information system leverages only one “set of books”, and allows that one “set of books” to be objectively multi-dimensional. This enables real-time analysis of the accounting data. Instead, all transactions are recorded in accordance with the pre-determined accounting objective at the time the transaction is recorded. This makes real-time reporting, across various accounting objectives, possible and increases reporting relevancy.

### CROSS-REFERENCE TO RELATED APPLICATIONS

This application is related to co-pending U.S. utility patent application with application Ser. No. 14/593,438 entitled “A COMPUTERIZED ACCOUNTING INFORMATION SYSTEM AND A METHOD OF PROCESSING ACCOUNTING DATA,” filed on Jan. 9, 2015, and having attorney docket number 20071.1050, which is a continuation in part of then co-pending U.S. utility patent application with application Ser. No. 13/560,528 entitled “CUSTOMIZABLE APPLICATION,” filed on Jul. 27, 2012, and having attorney docket number 20071.1010, both of which are entirely incorporated by reference herein. This application also is related to co-pending U.S. utility patent application with application Ser. No. 15/371,169 entitled “A CUSTOMIZABLE COMPUTERIZED ACCOUNTING INFORMATION SYSTEM AND METHODS OF PROCESSING AND SECURELY EXCHANGING ACCOUNTING DATA,” filed on Dec. 6, 2016, and having attorney docket number 20071.1060, which is (1) a continuation in part of then co-pending U.S. utility patent application with application Ser. No. 13/874,476 entitled “SECURE DATA EXCHANGE TECHNIQUE”, filed on Apr. 30, 2013, and having attorney docket number 20071.1031, which is a continuation in part of application Ser. No. 13/560,528 entitled “CUSTOMIZABLE APPLICATION”, filed on Jul. 27, 2012, and having attorney docket number 20071.1010, all three of which are entirely incorporated by reference herein, and which is (2) a continuation in part of then co-pending U.S. utility patent application with application Ser. No. 14/593,438 entitled “A COMPUTERIZED ACCOUNTING INFORMATION SYSTEM AND A METHOD OF PROCESSING ACCOUNTING DATA”, filed on Jan. 9, 2015, and having attorney docket number 20071.1050, which is a continuation in part of then co-pending U.S. utility patent application with application Ser. No. 13/560,528 entitled “CUSTOMIZABLE APPLICATION,” filed on Jul. 27, 2012, and having attorney docket number 20071.1010, both of which are entirely incorporated by reference herein, and which is (3) a continuation in part of then co-pending U.S. utility patent application with application Ser. No. 15/164,346 entitled “CUSTOMIZABLE APPLICATION”, filed on May 25, 2016, and having attorney docket number 20071.1011, which is a continuation of application Ser. No. 13/560,528 entitled “CUSTOMIZABLE APPLICATION”, filed on Jul. 27, 2012, and having attorney docket number 20071.1010, both of which are entirely incorporated by reference herein.

### BACKGROUND

The present disclosure relates to a system and method for data management and, more particularly, to an improved computerized accounting information system and a method of processing accounting data.

Tracking economic actions (e.g., accounting for transactions) is imperative to increasing productivity, measuring progress, and accumulating wealth (and to proper tracking and projecting of the accumulation of wealth). Historically, as business ventures increased, complexity increased. In order to trade fairly with one another, methods of recording economic activity were developed. Over long periods of time the communication of that activity reached higher levels of refinement as each preceding recording framework was accepted by tradesmen. As the concepts of “assets obtained”, “liabilities incurred”, “wealth accumulated”, “revenues generated”, and “expenses incurred” were defined and agreed to by trading partners, the essential framework of accounting became established.

This framework reflected the objectives of the tradesman and allowed him to pursue and attain his ideal operating environment. The emergent system of financial balancing eventually replaced earlier attempts to streamline business transactions and over time was generally accepted by market participants as fairly and accurately reflecting the economic reality in which all tradesmen operated. In some cases, especially the areas of taxation and governance, the accounting rules were codified. In recent times, the codification of tax rules and regulation expanded into the very market itself and expressed itself in accounting terms and concepts which generated standards to be followed to raise capital from investors and incur debt with creditors. This efficient system of accounting enhanced trust among all transactional parties and increased private productivity.

With that fundamental historical context in mind, the significant advancements in data measurement and collection of the past century have made obtaining relevant and competent accounting data relatively easy and inexpensive. Despite the obvious benefits, one result of this copious data intake is the creation of a new burden on data collectors. It is well known that data is worthless if it is not organized in a manner that allows the data collector to distill meaning, extrapolate inferences, and find pertinent data effectively and efficiently. Consequently, data management software has become a ubiquitous tool for holding, organizing, and facilitating the analysis of vast amounts of data. Current data management software is, unfortunately, deficient.

Current data management software generally takes the form of a digital database that stores discrete datum points, organizes the datum points into fields (to distinguish certain types of datum from other types of datum) and provides analytical tools (e.g., arithmetic and statistical) for the analysis of the data, under a specific accounting schema. The structure of the data, and the way the data is managed and arranged, and is not handled much different from how things were prior to the electronic age.

As an aside, data management software is very beneficial for the field of financial accounting, which relies heavily on analyzing vast amounts of financial accounting data. Financial accounting data is generally vast because of the nature of the accounting practice itself. Accounting relies on a thorough collection and analysis of all transactions over a fixed period of time, and a breakdown/parsing of these transactions into components that can fit into some sort of pre-established schema that provides order (described more thoroughly at the start of this Background section).

A plurality of different financial documents, based on the accounting data and those arbitrary yet meaningful schema, tell the financial story of a financial entity over that period of time and provide insight into how the financial entity is doing (as compared to the past) and how the financial entity is projected to do in the future (based on data previously collected). This story includes an assessment of the cash flows, debts, accounts receivable, liabilities, equities, incomes, losses, taxes, etc. This is where the data management software becomes most useful—brute force processing of vast amount of accounting data—even though the ways in which the accounting data is processed, by the electronic processor, is not much different from the way it would be processed if done as a mental-step, or on paper ledgers.

Further, financial accounting data is especially unique in that it is typically a combination of empirical information (e.g., monetary values and tax percentages) and non-empirical judgment characterizations. For example, a financial accountant compiling financial accounting data for a specific financial entity must generally follow a specific accounting regime for each jurisdiction/sector/industry in which they have to produce financial documents. The reason being that many jurisdictions (typically, different nation-states) have different tax rates, different laws governing the characterizations of different financial transactions and, sometimes, different generally accepted accounting procedures/methods to follow. Therefore, even though the same empirical information is coming into the data management software, that empirical information may be characterized differently by the financial accountant depending on the particular accounting regime being followed.

Returning to the deficiencies of current data management software: Because of the different accounting regimes, a financial accountant must generally use extra and discrete data management software records for each accounting regime governing the characterization of that financial entity's accounting data. To go along with each of these extra and discrete data management software records, the financial accountant may need to keep a log/record of the rational behind the judgment characterizations made by the financial accountant under each accounting regime. This log is needed because it is difficult for the financial accountant to keep track of each specific judgment characterization for each specific accounting regime for each specific datum point. Moreover, in order to produce reports which conform with another (or multiple) schema, standards, etc., accountants use a mixture of: spreadsheets, other software packages such as income tax preparation programs, Word documents, written notes, and printed financial forms required by various governing agencies.

Further, it is not uncommon for the jurisdiction/sector/industry to make significant changes to the accounting regime throughout the life of a financial entity. This results in financial accounting data records for a specific financial entity wherein one range of data records under a specific accounting regime have different rationales for the judgment characterizations than another range of data records under that same specific accounting regime.

The main deficiency is related to the accountants need to produce various reports using differing standards (principles, edicts, regimes, etc.) while being restricted to automatically produce reports under one standard. This is especially onerous when changes to the accounting books are required and those changes must be made manually to various spreadsheets, other software programs (and those software program are not usually accounting software programs), and notes in a client's file (sometime hand notes and post-its). Then those changes must be reflected in different reports, even impromptu requests by business management or internal/external auditors.

Further, and with more specificity, accountants are often required to maintain several sets of books to meet imposed objectives. In order to borrow money and raise capital, the operations of the business must be recorded using principles which most businessmen would agree most fairly states the financial position and operating results of the entity. Over time, accounting practices (that is how to classify and measure economic activity) have been generally accepted in the business marketplace by creditors, investors, buyers, sellers, etc. as fairly representing the financial activity of the enterprise. As these practices were adopted in the marketplace, they at some point became established principles, which market players (those creditors, investors, customers, vendors, insurers, lawyers, etc.) accepted as “truly” representing economic transactions in an impartial and objective manner. These accounting practices became known as generally accepted accounting principles (GAAP.)

However, being subject to various taxing authorities and corresponding tax laws, entities have also been required to measure assets, liabilities, equity and operations in accordance with those prevailing laws. Often, the tax laws differ among international, national, state, and local regimes necessitating maintenance of separate books in order to comply with each tax jurisdiction and remit appropriate taxes. Tax accounting is based on GAAP but has differences, for example, depreciation accounting, and due to its prevalence and requirement on U.S. companies, is also generally accepted.

In addition to maintaining a set of books for financial reporting and calculation of appropriate taxes, various regulatory environments promulgate the measurement and reporting of the entity's activities in financial reporting which reflect the codification of various environmental laws, state mandated capital requirements, insurance regulations, and other regulatory requirements. These various promulgations may require different accounting for the same transaction in order to comply with that particular law.

For example, for a particular type of transaction or cost-measurement, depending upon which particular standard is being followed, the resulting accounting may yield different values. Say an accountant is working under GAAP, and a building construction is being accounted for. Under GAAP, the standard guides the accountant towards an understanding of how to allocate the costs associated with that construction (e.g., the transaction(s)). GAAP may guide the account towards an understanding of which portion of the costs may go into the Cost of the Building table, and which portion of the costs you may be able to Expense, and which portion of the costs may go into the Structure of the Building table, and the Land table (“each portion of the costs” is this disclosure is interchangeable with “each portion of the specific transaction”). So if the accountant is preparing a financial statement based on GAAP, then the accountant is going to follow the standards and come up with an answer, and the accountant is going to yield a report indicating the final Cost values under GAAP.

Now, if the accountant is reporting under the IFRS schema, then there could be different ways, and guidance, for accounting for those same costs/transactions. So where as the accountant may have put some costs into Land for GAAP, the accountant may not be able to put those same costs into Land for IFRS. Instead, the accountant may be able to put those same costs into Structure, or into Land Capital tables, etc.

As such, in the accounting world, an accountant may take the same source—transactional level—data (because a check paid to a contractor is cash spent, and “cash spent” is usually just “cash spent”, regardless of the standard), but depending on the standard being utilized, the accountant may get a different Balance Sheet, etc., when accounting for that same cash spent transaction. Or a different Depreciation value, as between the GAAP accounting set of books and the Tax Accounting set of books. At one extreme, depending on the differences between the standards, some items may end up on the Balance Sheet for GAAP purposes, but under the Income Statement for IFRS purposes.

This underlies a fundamental problem facing the modern accountant using current data management software and how it structures accounting data. That is: when an accountant has to operate under numerous standards for accounting for the same transaction, it is very difficult to track and reconcile the accounting, especially as time proceeds. This is magnified when you also have to account for Managerial (internally-dictated) Accounting, Income Tax Reporting Standards, Regulatory Reporting Standards for Environmental Regulations, Carbon Taxes, etc. Further, and related to the above, there really is no good way for an accountant to track all the different prominent, and potentially useful, schema/standards of accounting for the same source data.

Usually, the accountant ends up using spread-sheets based on GAAP, and then if there is tax accounting, there is tax accounting systems used, and then there is one set of spread-sheets dedicated to reminding the accountant what the differences are between his creation of the GAAP set of books and the Tax Accounting set of books. Seldom does an accountant fully reconcile the two sets of books as this is a lot of work, and it doesn't necessarily yield useful data unless specific questions are being asked (as the partial reconciliation at least helps facilitate further updating to answer those questions).

In addition to the above, management objectives often require those same transactions to reflect reporting of capacity utilization, product gross margins, market pricing, costing of raw materials, allocation of overhead costs based on market practices, as well as internally generated measurements in order to achieve competitiveness, profitability, market penetration, and/or increase market share, control operating costs, and any number of other management objectives, so that the entity may have the proper metrics and metrics analysis to understand how it compares to others, and so that the entity can remain viable and competitive in the marketplace. Managerial Accounting essentially facilitates recording transactions for management purposes, for internally dictated reasons, that are different than those reasons underlying the financial accounting schema.

Currently, computerized accounting information systems record transactions using one standard of many available standards (GAAP vs. IFRS, usually) then modify the resulting reports to comply with the directives of competing taxing jurisdictions, regulatory agencies, management requirements, etc. to conform with differing expectations. All of the modifications are made to the primary (and only) set of books at the reporting level to yield the new desired report. In particular, the primary set of books (where the transactions are recorded using one standard of many available standards) is usually considered a static set of books, and a common accounting process implemented into known computerized accounting information systems is to grab that completed, static set of books, and to generate another, separate static set of books under a different standard. This essentially involves the recordation of the same transaction level data twice, thrice, etc. (depending on the number of standards to be processed and considered) in separate static sets of books in separate duplicate entries within the system.

The current XBRL system apparent from the prior art is designed for “Wall Street”—institutional investors and creditors—and it supposedly intended to solve some problems facing the modern accountant. Although the XBRL framework and reporting structure reflects GAAP, the concepts inherent in GAAP itself is influenced and thereby defined by those same institutional players. It is in essence a self-fulfilling prophecy for these players, but it also limits the system for everyone else.

The standards (GAAP/IFRS/unnamed or unmapped) discussed herein have existing taxonomies, which the combined effort of the business market (accountants, bankers, investors, creditors, etc.) and regulators (government) have developed over the last 20 or so years (as previously mentioned). Here's the problem: since the powers-that-be (economically speaking) define the important ideas in the business marketplace, albeit meaningfully yet arbitrarily and conservatively, those ideas eventually become “codified” and so generally-used as GAAP or IFRS, that then everyone (e.g., accountants) is forced to use those “standards”.

This is what has happened to current data management systems; these systems provide order and context, to bulk-processed accounting data, but that order/context/structure is tainted with the inherent premises and assumptions, and derived correlations and expected relationships, that define the current dominant schema/standard/principle (see the historical narrative presented herein).

In order to make economic progress, free economic ideas must be available to be expressed and tested. For the schema/standards/principles to become tried and vetted, they must become commonly used and iteratively improved, and they all must exist in a relational taxonomy. Currently, the only ones that meet these criteria are GAAP and IFRS (because of their ubiquity and prevalence in the field). However, as mentioned herein, they are inherently designed to meet the needs of those institutional players (because they determine what is meaningful, etc.). This doesn't help the rest of the Main Street players—about 80% of the market players.

Consequently, because of the stated significant deficiencies in presently available data management software, there is a need in the art for an improved computerized accounting information system and a method of processing accounting data.

### SUMMARY

The present disclosure describes various embodiments, as well as features and aspects thereof, of a computerized accounting information system. More specifically, one exemplary embodiment of a computerized accounting information system allows the accountant to avoid using a spreadsheet, having to set up the same entity in various different sets of books, and having to deal with the implications of tracking these various accounting standards. Instead, the computerized accounting information system leverages only one set of books, and allows that one set of books to be multi-dimensional. This allows the user of the system to record a transaction(s), one time, in multiple dimensions.

This enables real-time analysis of the accounting data (which could invoke financial modeling tools). In the prior art, reports are generated using one principle or standard and if the accounting is to be presented using another principle the cumulative data contained in those reports are “migrated” to the 2^{nd} accounting principle. So, the migration is another step in producing prior-art, differential reporting; whereas, no “migration” is needed for this exemplary embodiments. Instead, all transactions are recorded in accordance with the pre-determined accounting principles at the time the transaction is recorded. This makes real-time reporting possible and increases reporting relevancy.

As for prior art XBRL reporting, it is designed for the capital marketplace irrespective of any internal (organizational) accounting needs. This exemplary embodiment is configured to anticipate differing needs/arbitrary standards (internal vs. external—i.e. operating vs. financing) and is not restricted by outside market rules. It facilitates internal financial and risk management analysis (among others) while accommodating external reporting requirements in a semi-automated manner (the “migration” process is not needed.)

Further, one exemplary embodiment of a computerized accounting information system facilitates compliance with institutionally mandated objectives (as expressed via Country-GAAP and Country-IFRS, for example). The computerized accounting information system expedites and makes the process of communication/compliance reporting more efficient by handling the divergence standards (institutionally imposed, although sometimes referred to as GAAP/IFRS), all at the transactional level. The computerized accounting information system records one transaction, one time, in accordance with multiple standards.

In other words, at the time of recording one transaction, if a standard divergence exists (GAAP vs. IFRS, for example) then the system is not forced to make an either/or decision. The recorded transaction embraces both standards, i.e. the transaction is recorded in such a way to be compliant with both standards, so that when a GAAP report is need, then the user simply commands the system to generate “X” report using the GAAP standard, and the report is generated. If the same report needs to be generated using IFRS, then the user simply commands (by simply choosing the desired reporting standard from a list of choices in the report menu) for the IFRS standard, and the report is generated by utilizing that standard.

The exemplary computerized accounting information system is not restricted to compliance with standards (e.g., GAAP, IFRS—in all their variances dictated by the particular country with jurisdiction over the entity), but extends to recording one transaction in accordance with other criteria, that criteria being other objectives and even other concepts. So, if a difference exists between the GAAP and income tax rules, for example, not withstanding the IFRS rules, then the system will facilitate recording the transactions in accordance with those income tax rules. This approach is non-restrictive in that the same transaction may also be recorded in accordance with management objectives as well. The proposed system solves the problem of how to report economic activity using different ideas/schema/standards than those established/embedded from the past.

Further, one exemplary embodiment of a computerized accounting information system, and the underlying process, comprises mapping the accounting concepts existing in a specific standard/schema by an intelligent agent (e.g., an external accountant or an artificial intelligence or a machine-learning system). To the extent that a direct relationship (one-to-one) exists between a similar and the same concept in standards/schema, the mapping is straightforward to human accountants, machine learning, artificial intelligence/neutral nets. Cash in GAAP is the same as cash in IFRS, for example. Where one concept may have a relationship to multiple concepts (one-to-many) the system (under the direction of the accountant, for example) may utilize (among many choices) other criteria in the transaction to determine the appropriate concept to map to in the second standard/schema. This may be accomplished by using a weighting system as part of the taxonomy, usage of other concepts (from other taxonomies, accounting or non-accounting, for example) in the transaction or outside of the transaction (such as global market data), or other methods for the computer to “know” which concept to map to. In the last case, the user may be offered a choice of concepts to map to into the second taxonomy with recommendations. So, in a nutshell, the mapping is accomplished automatically with pre-established criteria from information inside or ancillary to the transaction itself, or aided with the interaction of the intelligent agent of the system, via an interface, or from outside data sources external and independent from the system.

Further, one exemplary embodiment of a computerized accounting information system comprises a data entry module, a command receiving module and a processing module. The computerized accounting information system is configured to receive data entries relating to various transactions and to comply with various accounting standards. The computerized accounting information system is also configured to process a method comprising the actions of receiving, analyzing, and securely exchanging data entries for a variety of types of data fields that comply with a variety of accounting standards. In this way, the computerized accounting information system can more efficiently and effectively process accounting data entries and produce analytical financial accounting actions.

In another exemplary embodiment, the business management system does not make judgment characterizations under each accounting standard like a human financial accountant (which requires learned rationales, for example). Nonetheless, the accounting standards handled by the business management system may have certain elements/computations caked in, which are well known, stable, and capable of machine processing. As such, via modern machine learning algorithms, those portions of the accounting standard may be characterized by the computerized accounting information system, and the well-known, formulaic, and established rules may be leveraged by the computerized accounting information system to evaluate/parse/process business data to find discrepancies, for example. Moreover, the computerized accounting information system may be configured to do auto-complete functions for those portions of the accounting standard(s) as well as various other functions described herein.

In this way, the business management system of the present invention may operate as a computerized accounting information system that presents organized interpretations/judgment characterizations of gathered accounting information/data. The computerized accounting information system may operate as a tool that provides semantic information, that is, information about the relation between the gathered information and generally recognized accounting standards or “concepts.” The computerized accounting information system may, therefore, also operate as a taxonomy(ies)—a description and classification system for the concepts.

Within the computerized accounting information system, one exemplary data structure envisioned comprises two primary components. The first is a set of fields (referred to as “tags” or “concepts”) that are associated with a transaction record. Each transactional record may have a different set of tags/concepts for as many taxonomies that are handled by the system. The second component is a mechanism by which output is generated and transmitted to the various client applications/invocations of the system. This output is delivered in the format defined by a user-specified taxonomy, for example.

In another exemplary embodiment, the business management system allows for the use of a single system with entered/collected data to support various applications beyond simply accounting. For instance, taxonomies (described in greater detail herein) can be set up for risk management, environmental monitoring, etc. and handled by the system. Data collected at least for purposes of the accounting field can be correlated from the accounting taxonomy to another. For instance, purchases and sales transactions, important to the accounting functions of the system, entered/collected via the system can also be accessed by other taxonomies as supportive data. In one non-limiting example, a manufacturing company/entity using the business management system may get energy credits based on certain purchases and sales. If the manufacturing company purchases a certain kind of product, that purchase can be recorded by the system for the accounting taxonomy as a purchase but, then the model number data can be read in by the environmental taxonomy to determine if energy credits are due and the environmental taxonomy can track and report an accounting of energy credits. Various other uses and embodiments are envisioned.

Furthermore, the present disclosure describes various embodiments, as well as features and aspects thereof, of a computerized accounting information system that implements a technique for the secure exchange of data between multiple business entities/end-users that use compatible business management systems. More specifically, one exemplary embodiment of a computerized accounting information system utilizes serializable data transfer objects to transfer business/accounting data over a secure communication path. This eliminates the need for an active user connection between entities needing to exchange business/accounting data. The data contained within the transfer objects can be used by any participating entity to update existing records related to the transaction, or to create new records relating to the transaction. Serializable objects link all data relating to a given business transaction. An interface allows users to view data contained in or referenced by an object, and to create or modify transaction records based on the data.

In another exemplary embodiment of the computerized accounting information system, the system is characterized by a novel technique for securely exchanging electronic accounting data between multiple entities that share a common accounting link and that utilize the same business management system, without compromising the confidential or otherwise unauthorized data of any of the entities. In one non-limiting example, the technique utilizes data transfer objects that can be serialized. The serialized data transfer objects are used to share business data over a secure communication path, eliminating the need for an active user connection between entities wishing to exchange data. The data contained within the transfer objects can be used by any participating entity to update existing records related to the transaction, or to create new records relating to the transaction. Security of business data between the participating entities is maintained both because there is no remote user connection between any of the participating entities, and because the participating entities have the option of accepting or not accepting the data being exchanged into their business management systems. In addition, a comprehensive audit trail of records relating to the transaction is created.

The secure data exchange technique can be utilized in a variety of business settings and computing environments. As a non-limiting example, it can be part of a web-based or web-centric accounting and general ledger system in a client-server configuration. One implementation of the technique contains a user interface in the client module that sends information to the server and receives information requests from the server, and a server module that receives information requests from the client and sends information to the client. Data relating to a business transaction to be exchanged is organized into a serializable transfer object, which is then transmitted over a secure communication path to the other participating entity or entities. The data contained in the transfer object can be accessed by users of the participating entities and used to update their own existing records relating to the transaction, or create a new record relating to the transaction. Because the transfer object is serializable, whenever any of the participating entities creates a new record or modifies an existing record relating to the transaction, the transfer object is modified with the data contained in the new or modified record. The result is that the transfer object contains and maintains a comprehensive documentation “chain” of all the data relating to a business transaction that can be accessed by any of the entities participating in the transaction.

In general, embodiments of the secure data exchange technique operate to share business data related to a given transaction between participating entities by using data transfer objects to link the data contained in the business records of each participating entity. In this way, the computerized accounting information system of the present disclosure helps resolve prevalent issues in the field, namely, the cost of conversion software, the cost conversion services, or both. Additionally, the purchase of readily available computerized accounting information systems may require a user business entity to update or replace some or all of its hardware. Another obstacle is that many small business users do not have dedicated IT employees with the knowledge or expertise to handle a data integration project. Another obstacle is the preparation and training for the new technology, which can be so disruptive to the daily operations of a small business user that current revenue and customer relationships may be adversely affected. Obstacles like these as well as others, even if only perceived, can make small business user very reluctant to undertake data conversion projects, regardless of how affordable or seamless their implementation might actually be. Luckily, the computerized accounting information system of the present disclosure helps resolve these issues.

Various embodiments, configurations, features and aspects of the computerized accounting information system and the method of processing accounting data are described in more detail in the detailed description with reference to the attached drawings.

### BRIEF DESCRIPTION OF THE SEVERAL VIEWS OF THE DRAWING

FIG. 1 is a functional block diagram of the components of an exemplary environment or platform in which various embodiments of a computerized accounting information system and a method of processing accounting data may be implemented.

FIG. 2 is a functional block diagram of platform 100 of FIG. 1 implemented with one exemplary embodiment of a computerized accounting information system 200 and accessible by one exemplary embodiment of an end-user platform 205.

FIG. 3 is a functional block diagram of one exemplary embodiment of a functional environment in which a computerized accounting information system can be implemented.

FIG. 4 is a block diagram of the components of an exemplary web server residing in a J2EE based architecture.

FIG. 5 is partial view of an exemplary screen structure selected from many available screen structures for a computerized accounting information system.

FIG. 6 is a conceptual diagram of one exemplary embodiment of an implementation of the server side logic of the exemplary web server residing in a J2EE based architecture.

FIG. 7 is a block diagram of the exemplary use of a secure communication path between participating entities implementing the computerized accounting information system.

FIG. 8 is a conceptual diagram of the components of an exemplary data transfer object for a client-server object oriented architecture.

FIG. 9 is a block diagram of an exemplary embodiment of a business management system/computerized accounting information system of participating entities Company A and Company B, and the secure communication path between the two entities.

FIG. 10 is a functional block diagram of an exemplary embodiment of a computerized accounting information system having multi-dimensional general ledger structure.

FIG. 11 is a functional block diagram of an exemplary embodiment of a computerized accounting information system having a non, multi-dimensional general ledger structure.

FIG. 12 is a flowchart diagram illustrating a first set of actions that may be implemented by the various embodiments of the computerized accounting information system of the present disclosure, or that may be included within a method of processing accounting data.

FIG. 13 is a flowchart diagram illustrating a second set of actions that may be implemented by the various embodiments of the computerized accounting information system of the present disclosure, or that may be included within a method of processing accounting data.

FIG. 14 is a flowchart diagram illustrating a third set of actions that may be implemented by the various embodiments of the computerized accounting information system of the present disclosure, or that may be included within a method of processing accounting data.

FIG. 15 is a flowchart diagram illustrating a fourth set of actions that may be implemented by the various embodiments of the computerized accounting information system of the present disclosure, or that may be included within a method of processing accounting data.

FIG. 16 is a flowchart diagram illustrating a fifth set of actions that may be implemented by the various embodiments of the computerized accounting information system of the present disclosure, or that may be included within a method of processing accounting data.

FIG. 17 is a flowchart diagram illustrating a sixth set of actions that may be implemented by the various embodiments of the computerized accounting information system of the present disclosure, or that may be included within a method of processing accounting data.

FIG. 18 is a flowchart diagram illustrating a seventh set of actions that may be implemented by the various embodiments of the computerized accounting information system of the present disclosure, or that may be included within a method of processing accounting data.

FIG. 19 is a screenshot of one non-limiting embodiment of an end-user interface as it might appear to an end-user.

### DETAILED DESCRIPTION OF VARIOUS EMBODIMENTS

The following written description explains various embodiments of a computerized accounting information system and a method of processing accounting data. Various embodiments, as well as features and aspects that may be incorporated into some embodiments, are presented in this description.

This written description refers to the appended drawings to supplement the written explanation. As such, the written words should not be construed as limitations. Numerous specific details are explained in the written description and depicted in the drawings to provide an enabling understanding of the various embodiments to one having ordinary skill in the art. Some details, however, need not be expressly explained because they would be readily apparent and understood by one having ordinary skill in the art. For example, certain described embodiments and explanations of some specific details are omitted so as to not unnecessarily obscure the written description. Additionally, one having ordinary skill in the art would understand that the various embodiments might be practiced without some or all of these specific details.

For purposes of this disclosure, the term web-based application will be described as an application client that runs or executes an application but that initially obtains one or more components for the application from a server or servers that are accessed via a network, such as the World Wide Web or some other network including local area networks, wide area networks, or the like.

A person of ordinary skill in the art understands that taxonomies are obtained when several fundamental divisions of gathered information are considered in succession, rather than simultaneously. Generally speaking, a taxonomy is obtained when a narrow set of procedures and rules are applied to gathered information for the purpose of (1) describing/labeling the information and (2) producing classifications based on the relation between the gathered information and the general “concepts.” For purposes of a taxonomy, a “concept” (like an accounting standard) refers to the user/creator of the taxonomy's arbitrary and subjective understanding of a set of information and how individual information points within the set are or are not like other individual information points.

Furthermore, a taxonomy may be more clearly defined as an ordered classification system where information is grouped, like with like, according to presumed natural relationships such that the structure of the taxonomy is consistent with a user's/creator's conceptualization of the subject of the information. As such, a taxonomy is not simply a neutral structure for categorizing the information; instead, it implicitly embodies the user/creator of the taxonomy's theory of how the individual information points operate and relate to one another, as well as to other types of information.

A well-known example of an implemented accounting taxonomy is the XBRL taxonomy. The XBRL taxonomy is a particular way to describe and classify accounting reporting concepts. XBRL represents each concept as an element with a name. The XBRL US GAAP Taxonomy describes and classifies elements representing US GAAP reporting concepts. XBRL taxonomies are electronic, machine-readable “dictionaries” consisting of many linked files containing thousands of elements linked to each other. The taxonomy contains human-readable labels such as financial statement line item captions, definitions, and applicable authoritative references for each element.

The XBRL US GAAP Taxonomy is based on generally accepted accounting principles in the United States and is intended for SEC registrants who file financial reports prepared in accordance with US GAAP. The XBRL US GAAP Taxonomy has broad and deep coverage of financial reporting concepts including all US GAAP and SEC financial statement disclosure requirements and many elements for commonly followed reporting practices. The taxonomy's size and breadth minimizes the effort required to extend the taxonomies to meet specific reporting needs.

Although throughout the detailed description the various embodiments are directed towards a computerized accounting information system and a method of processing accounting data, it should be understood that the focus of such description is only to ensure clarity in the configuration and operation of the various embodiments. The description should not be used to limit the usefulness of the various embodiments in other manners or for other uses.

Embodiments and aspects of the present invention provide a computerized accounting information system, and a method of processing accounting data, that can more efficiently and effectively process accounting data entries, for various types of data fields, that comply with various accounting standards and produce analytical accounting actions. More specifically, the system or method is configured to give an end-user quick and simple access to accounting data entries, which have been characterized by various accounting standards, without the need for disparate data records or out-of-system explanatory logs for the accounting standard characterizations. Furthermore, the system or method is configured to leverage these data entries produce accounting standard specific analytical accounting actions that include the production of reports, tax returns and other similar financial statements known to one having ordinary skill in the art.

To secure the communication path, a protocol such as HTTPS can be utilized as a non-limiting example. HTTPS, which is an acronym for Hypertext Transfer Protocol over SSL, is a protocol utilizing TCP to transfer hypertext requests and information between servers and browsers. When HTTP utilizes SSL, which is an acronym for Secure Socket Layer, or TLS (Transport Layer Security), the protocol is referred to as HTTPS. Thus, in the illustrated example, communication between the application client 110 and the server 120 is conducted by a combination of hypertext transfer protocol and SSL/TSL. The use of this protocol provides encrypted communication and secure identification of a network web server. HTTPS connections are used in many situations in which sensitive information is being communicated. For instance, HTTPS is frequently used for payment transactions on the world wide web as well as other connections in which sensitive information may be communicated. The detailed operation of HTTPS and the involvement between the various communication network layers is not addressed in detail in this description as those of ordinary skill in the relevant art will be familiar with the technical aspects of HTTPS. As such, only a high-level overview of the technology is presented.

In the TCP/IP protocol stack, the SSL protocol sits between the TCP/IP layer protocol and the higher application-level protocols such as HTTP or SMTP. The SSL based implementation calls TCP/IP on behalf of the application, and it allows the SSL-enabled server and the SSL-enabled client to authenticate to each other and establish the encrypted connection between the two endpoints.

Use of SSL server authentication allows a user to confirm a server's identity. An application client that incorporates SSL-enabled software can use standard techniques of public-key cryptography to check that a server's certificate and public ID are valid and have been issued by a certificate authority listed in the client's list of trusted CAs. Such authentication is important from a user's perspective prior to transmitting valuable and sensitive information to the server over the network.

The use of SSL client authentication allows a server to confirm a user's identity. Using the same techniques as those for server authentication, a server that includes SSL-enabled software or web application can check that a client's certificate and public ID are valid and have been issued by a CA in the server's list of trusted CAs. Such confirmation is important if the server will be sending confidential information to the client and wants to verify the identity of the receiving client prior to the transmission of the information.

It should be appreciated that other techniques can be used to provide the secured transmission of data and client/server authentication and that the use of HTTPS is only one non-limiting example. For instance, closed networks, closed communication channels, static signing, manual encryption, VPNs, etc. could also be utilized

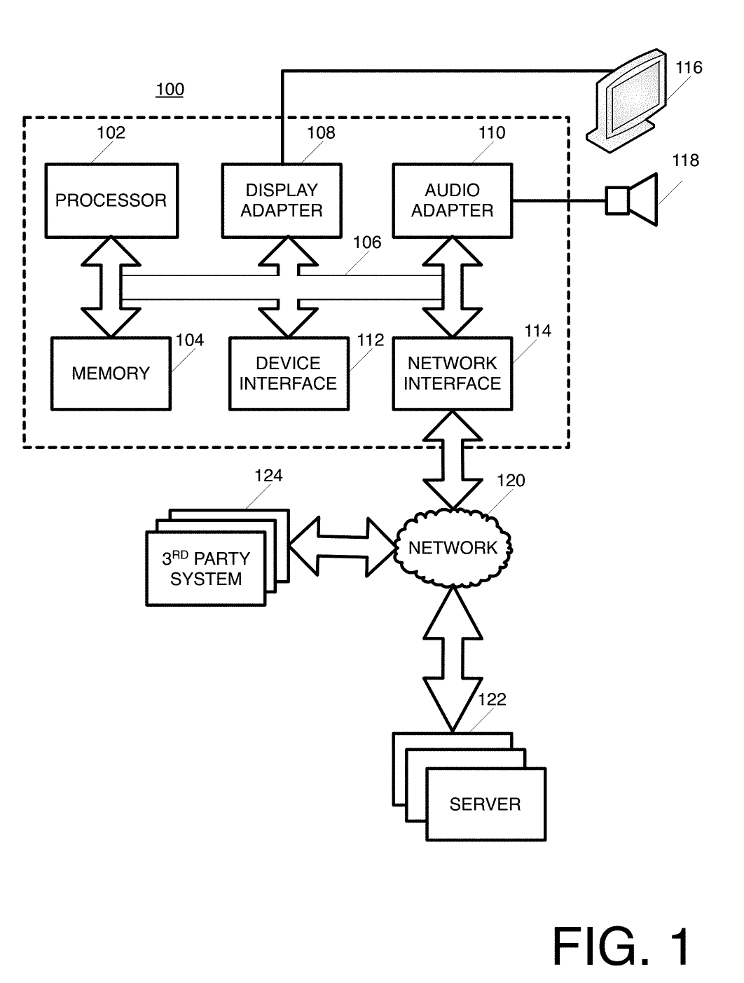

Turning now to the figures, FIG. 1 is a functional block diagram of the components of an exemplary environment or platform in which various embodiments of a computerized accounting information system and a method of processing accounting data may be implemented. It will be appreciated that not all of the components illustrated in FIG. 1 are required in all embodiments or implementations of the system or method, but each of the components are presented and described in conjunction with FIG. 1 to provide a complete and overall understanding. In addition, it will be appreciated that the embodiments of the system or method may be implemented in environments and/or platforms that may include other components and functionality. Therefore, the illustrated configuration is simply a non-limiting example.

The exemplary platform 100 is illustrated as including a processor 102 and a memory element 104. In some embodiments, the processor 102 and the memory element 104 may be communicatively coupled over a bus or similar interface 106. In other embodiments, the processor 102 and the memory element 104 may be fully or partially integrated with each other. The processor 102 may be any of a variety of processor types including microprocessors, micro-controllers, programmable arrays, custom ICs, etc., and may also include single or multiple processors with or without accelerators, or the like.

The memory element of 104 may include any of a variety of structures, including but not limited to RAM, ROM, magnetic media, optical media, bubble memory, FLASH memory, EPROM, EEPROM, etc. In addition, rather than being internal to the platform 100, the memory element 104 may be external to the platform 100 and accessed through a device interface 112 or a network interface 114.

The processor 102, or the other components of the platform 100, may also provide sub-components or functionalities such as a real-time clock, an analog-to-digital convertor, a digital-to-analog convertor, sensors, etc. The processor 102 may also interface to a variety of elements including a control/device interface 112, a display adapter 108, an audio adapter 110 and a network/device interface 114.

The control/device interface 112 may provide an interface to external devices, systems, equipment, sensor, actuators or the like. As non-limiting examples, the control/device interface 112 may be used to interface with devices or systems such as a keyboard, a mouse, a pin pad, an audio activate device, a gaming console, a gesture recognition sensor, an accelerometer, any other computer or processing device, as well as a variety of many other available input and output devices.

The display adapter 108 may be used to drive a variety of visually oriented elements 116, such as a display device including an LED display, LCD display, a Plasma display, a 3-D/holographic/virtual-reality display, one or more LEDs or other display devices, printers, etc. The audio adapter 110 may interface to and drive a variety of audible or other alert elements 118, such as a speaker, a speaker system, a buzzer, a bell, a vibrator, etc.

The network/device interface 114 may also be used to interface the platform 100 to any of a variety of other electronic devices or systems through a network 120. The network 120 may be a local network, a wide area network, a wireless network (WIFI, Bluetooth, cellular, 3G, LTE etc.), a global network such as the Internet, or any of a variety of other configurations including hybrids, etc. The network/device interface 114 may be a wired interface or a wireless interface.

The platform 100 is shown in FIG. 1 as interfacing to a server 122 and a third party system 124 through the network 120. Thus, the platform 100 may function independently, in connection with one or more systems, or even as a distributed system. It is envisioned that a battery or a power source provides power for the platform 100.

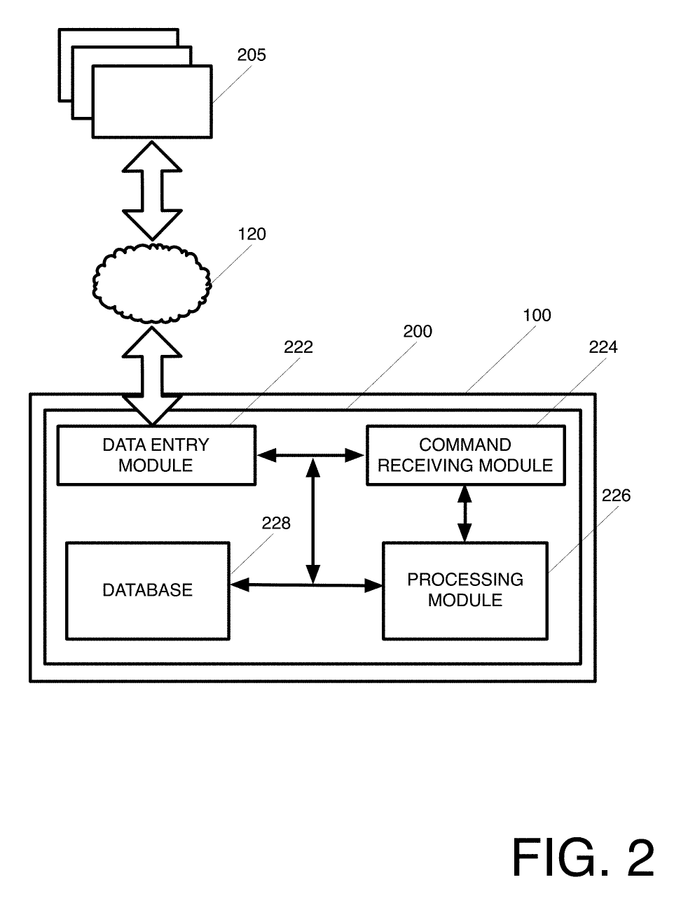

FIG. 2 is a functional block diagram of one exemplary embodiment of a computerized accounting information system. The computerized accounting information system 200 may be implemented on a platform such as the platform 100 of FIG. 1. Furthermore, the computerized accounting information system 200 may be accessible by one exemplary embodiment of an end-user platform 205. The computerized accounting information system 200 is comprised of a data entry module 222, a command receiving module 224, a processing module 226 and a database 228. However, the computerized accounting information system 200 may be comprised of various other modules or components providing any of a variety of functionalities not necessarily described in the following disclosure. Moreover, although the various functions are illustrated as being divided into various blocks, it will be appreciated that some of the functions may be implemented within common hardware, firmware and/or software components (such as those of FIGS. 1-2) and/or various functions may actually exist among two or more separate hardware, firmware and/or software components.

As should be understood by one having ordinary skill in the art, these components are communicatively coupled and may be dispersed throughout the architecture of the platform upon which the computerized accounting information system 200 is implemented. Furthermore, these components may be substantially discrete or may have considerable overlap, e.g., in terms of where, when and how they are stored, processed and operated. Therefore, FIG. 2's representation of these components as separate and distinct modules is merely for ease of description and visual representation and is not intended as a limitation or as the actual physical construction of the computerized accounting information system 200.

Moreover, in some exemplary embodiments, the end-user platform 205 is a data input device, or the like, that interfaces with the control/device interface 112 of the platform 100. Therefore, the end-user platform 205 may simply be an additional component of the platform upon which the computerized accounting information system 200 is implemented. On the other hand, the end-user platform 205 may exist as an entirely distinct environment or platform from the environment or platform upon which the computerized accounting information system 200 is implemented. Therefore, end-user platform 205 may be similarly configured as platform 100 of FIG. 1. As a result, it is envisioned that the end-user platform 205 may be communicatively coupled to a control/device interface, network interface, or any other similar component, through a network, or through any other applicable wired or wireless communications channel.

Moreover, in some exemplary embodiments, the data entry module 222 functions, at least in part, as an interface point between the end-user platform 205 and the computerized accounting information system 200. The data entry module 222 having the purpose of receiving, digitally storing and organizing the data entries from the end-user. Consequently, the data entry module 222 is configured to provide the end-user with the ability to label, categorize and/or organize data entries into fields (e.g., debits, credits, cash-flows in, cash-flows out, accounts receivable, liabilities, equity assets, capital assets, cash, debt, taxes). Furthermore, the data entry module 222 is additionally configured to aggregate data entries of different fields into over-arching transactions (e.g., the debits and credits involved with the sale of an asset as part of transaction 1 as distinct from the debits and credits involved with the acquisition of an asset as part of transaction 2). Furthermore, the data entry module 222 is additionally configured to provide the end-user with the ability to specify the accounting standard.

Because of the various physical locations wherein the data entry module 222 can be implemented, the data entry module 222 may take the form of a user-interface that is accessible remotely from the end-user platform 205 through a network, a wired connection, a wireless connection, etc. (e.g., stored in the cloud and accessed as online application or stored on a server and accessed through a webpage). Furthermore, the data entry module 222 may take the form of a packaged software bundle, or any downloadable piece of software known to one having ordinary skill in the art, that is implemented directly on the end-user platform 205 and which communicates with the other components of the computerized accounting information system 200.

Moreover, in some exemplary embodiments, the database 228 functions, at least in part, as the short-term or long-term storage for data entries received by the data entry module 222. The database 228 may be configured as a read-write medium capable of being accessed by the computerized accounting information system 200 or any other platform/system/software/module with need for the information stored therein. Therefore, the database 228 may be formatted to any standard known to one having ordinary skill in the art. Furthermore, the database 228 may be read and updated in real time by the data entry module 222 such that the user-interface can illustrate data entries, with their associated categorical/organizational/accounting standard metadata, that have been previously received by the computerized accounting information system 200. This function essentially allows the data entry module 222 to act as a browser for the information stored on the database 228.

Moreover, in some exemplary embodiments, the command receiving module 224 functions, at least in part, as an interface point for receiving a command to invoke an action within the computerized accounting information system 200. The received command may also identify the accounting standard pertinent to the desired action. The action invoked by the command may be any type of analytical accounting action, e.g., the production of reports, tax returns and other similar financial statements, that involves, at least in part, searching, compiling, discriminating, comparing and/or extrapolating meaning from the relevant data set. Consequently, the command receiving module 224 may be integrated, partially or fully, with data entry module 222 such that an end-user may specify the command directly within the user-interface. It is also envisioned that the command receiving module 224 may be stand-alone and capable of receiving the command, either pre-programmed or real-time selected, from other systems/platforms/environments.

Moreover, in some exemplary embodiments, the processing module 226 is configured to receive the data entries from the data entry module 222 and the command from the command receiving module 224 and perform the identified action. Because the command may also identify the account standard pertinent to the desired action, performance of the action by processing module 226 may be based, at least in part, on the identified accounting standard. As a result, the processing module 226 is configured to access the database 228 to leverage any other pertinent data entries previously received by the computerized accounting information system 200. The processing module 226 may also be configured to alert the end-user, at least in part, through the user-interface of the data entry module 222, if a data entry has not been received but that is needed for performance of the action. One having ordinary skill in the art should know that there are various methods and techniques for alerting an end-user that involve or do not involve the user-interface of the data entry module 222.

Because data entries may be labeled, categorized and/or organized into sub-fields and then aggregated into over-arching transactions, the processing module 226 may also be configured to recognize those sub-fields and to recognize those transactions most relevant to the identified action and the identified accounting standard in the command. Therefore, the processing module 226 may employ a smart logic to selectively search, filter and/or compile data entries for performing the identified action.

The processing module 226 may also be configured to analyze the data entries presently entered into the data entry module 222 (but not yet stored in the database 228) or the data entries previously received and stored in the database 228 (but not presently entered into the data entry module 222) for significant deviations from what would be expected as a consistent data entry under a particular accounting standard. Therefore, the processing module 226 may infer/extrapolate/compute this expected data entry based, at least in part, on a sample of related and relevant data entries under a similar transaction, or under a similar sub-field across a variety of transactions. The processing module 226 may provide an alert indicator if the data entries significantly deviate from the expected data entry. Additionally, the processing module 226 may be configured to prepopulate the data entry module 222 with a suggested place holder data entry (derived from the expected data entry) if the presently entered data entry significantly deviates from the expected data entry. This suggestion is intended to help guide the end-user to realize any possible mistakes in their data or in their characterization of the data using the intended accounting standard.

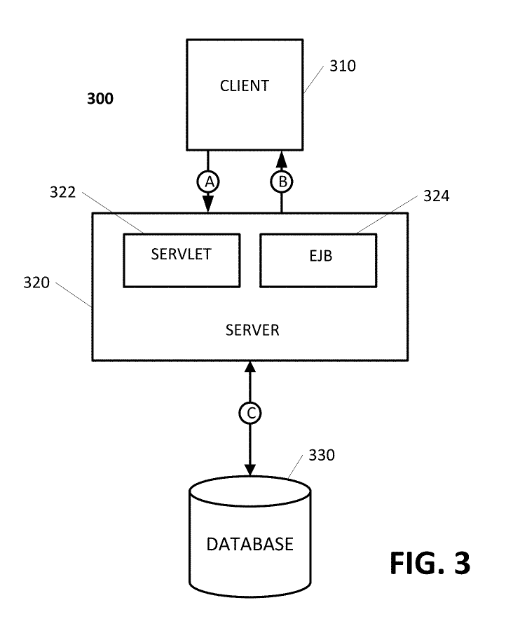

FIG. 3 is a functional block diagram of one exemplary embodiment of a functional environment in which a computerized accounting information system can be implemented. The exemplary computerized accounting information system 200 of FIG. 2 may be implemented within functional environment 300. Specifically, the environment 300 is an exemplary embodiment of a client-server application environment 300. The client-server application environment 300 is comprised of the components of an application client 310, a server 320 and a database 330. The description of FIG. 1 is applicable to the client 310 and server 320 and database 330 in certain exemplary embodiments.

Furthermore, the application client 310 is configured to communicate information to the server 320 over communication path A and receives communicated information from the server 320 over communication path B. A protocol such as HTTPS may be used to provide data privacy for information that is communicated between the application client 310 and the server 320 and enforces client authentication to limit access to the server 320 to authorized end-users. It will be appreciated by a person of ordinary skill in the relevant art that the computerized accounting information system 200 could be incorporated into any local or distributed computing environment and the illustrated example is just provided for purposes of explanation. Moreover, the communication protocol used between the application client 310 and the server 320 preferably enables a secured communication path but, it should be appreciated that in some embodiments, an unsecured communication path may also be utilized.

Furthermore, in describing the exemplary functional environment, the environment is presented as being based on Enterprise JAVA or J2EE technology. For the exemplary environment/platform of FIGS. 1-2, which emphasize a full-function accounting/book-keeping/ledger system (the computerized accounting information system 200, for example), a J2EE application that is broken down into three tiers is employed; the three entities being the application client 310 (client tier), the J2EE server 320 (web and business tier) and a database 330.

A person of ordinary skill in the art understands that the J2EE clients can be web clients or application clients. Web clients are generally described as being thin clients meaning that they do not query databases, execute complex business rules or connect with legacy applications. Application clients, on the other hand, are described as fat clients, run on a client machine and provide a richer user interface. Typically, such interfaces include a graphical user interface (GUI) created from the Swing or the Abstract Window Toolkit (AWT) API. When either configuration is utilized, these types of operations are generally performed by enterprise beans executing on the J2EE server. In typical J2EE based architectures, Javabeans are employed to manage the data flow between an application client and the components that are running on the J2EE server. Similarly, Javabeans are used to manage data flow between the J2EE server and the database.

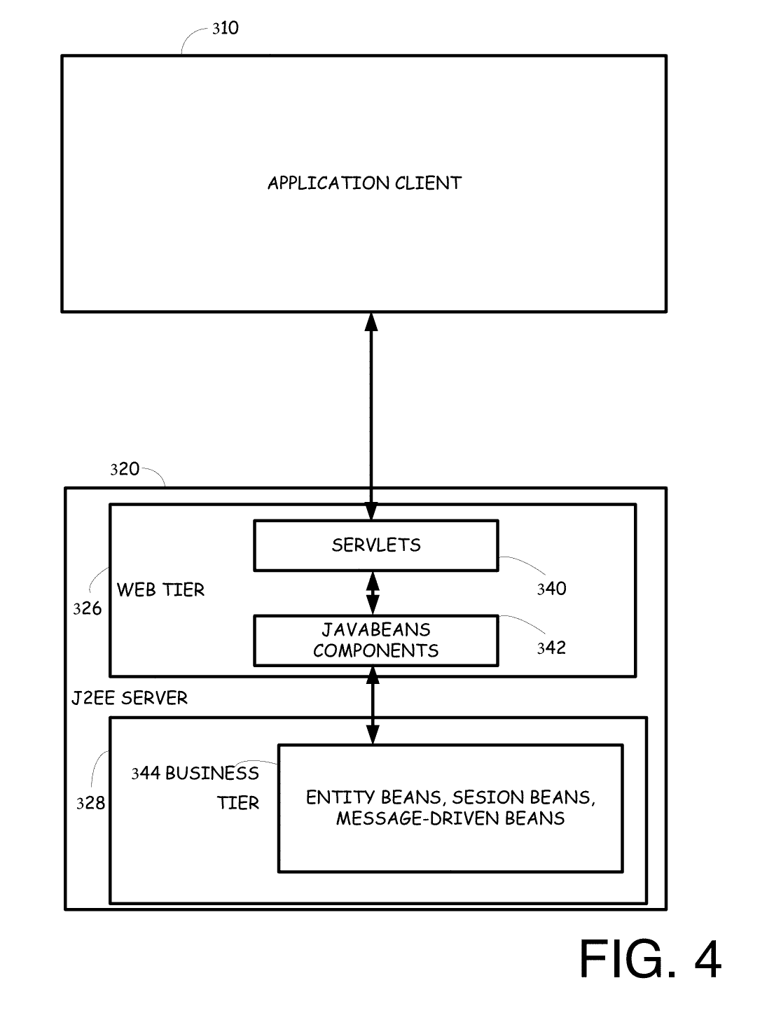

FIG. 4 is a block diagram of the components of an exemplary web server residing in a J2EE based architecture. The exemplary client-server application environment 300 of FIG. 3 may be implemented with the exemplary J2EE server 320 configuration. Specifically, the application client 310 runs on a client machine such as the end-user platform 205 of FIG. 2 and provides a way for users to handle tasks that require a richer user interface than can be provided by a markup language. It typically has a graphical user interface (GUI) created from the Swing or the Abstract Window Toolkit (AWT) API, but a command-line interface is certainly possible. The application client 310 directly accesses enterprise beans 344 running in the business tier 328 of the J2EE server 320. However, if application requirements warrant it, an application client 310 can open an HTTP connection to establish communication with a servlet 340 running in the web tier 326 of the J2EE server 320.

In a particular embodiment, the application client 310 is based on a java program, with a GUI rendered through Java Swing, that communicates with the J2EE server 320. The web tier consists only of servlets 340 and the business tier consists of the beans 344 (entity beans, sessions beans, message-driven beans, etc.).

The application client 310 communicates with the business tier 328 running on the server through the servlets 340 that are residing in the web tier 326 and JavaBeans components 342 that interface to the enterprise beans 344 residing in the business tier 328 on the server 320. Other details of the J2EE architecture and the deployment and development of entities within such an environment are known in the art and further detail is not presented herein.

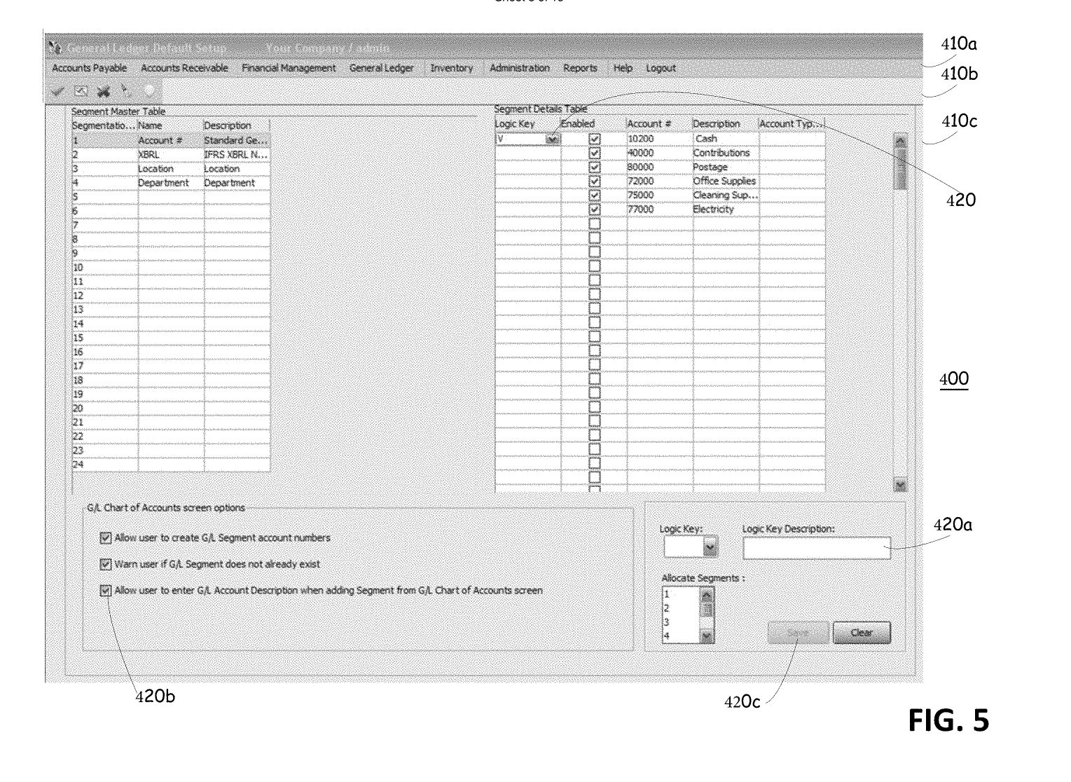

FIG. 5 is partial view of an exemplary screen structure selected from many available screen structures for a computerized accounting information system. The exemplary screen structure 400 may be processed and interfaced with at the application client 310 on a client machine such as the end-user platform 205 of FIG. 2. The screen view is based on SWING and Java Foundation classes, but other design technologies could be employed. The exemplary screen structure 400 consists of various elements constructed using a jframe and jpanel classes. The jframe is the physical window that is illustrated on the screen 400. The jpanel defines the various components that are included in the screen. The screen can include a variety of formats such as an online form, etc. The jpanels are containers for the components. The various frames 410a, 410b and 410c are presented on the screen 300 and then the components for each jframe are then added to the jpanel. Various component types can be presented, such as jbuttons, jlabels, radial buttons, text boxes, etc. In general, as a user actuates the various jpanel components, the state of the components can change, such as adding text in a box 420a, toggling a radial button or check box 420b etc. Once items are modified on the screen, the user can actuate the save panel 420c which causes the transmission of the data or actuations to be sent from the web client 310 to the server 320 and for updating the database 330. When the save panel 420c is actuated, this information is transferred over communication path A (FIG. 3) to the servlets 340 and invokes JavaBeans 344 in the business tier 328 of the server 320. The business tier 328 also includes one or more JavaBeans for controlling communication with the database 330. In general, the screen 300 is constructed such that there is a servlet per menu and a JavaBean per menu item as a non-limiting example.

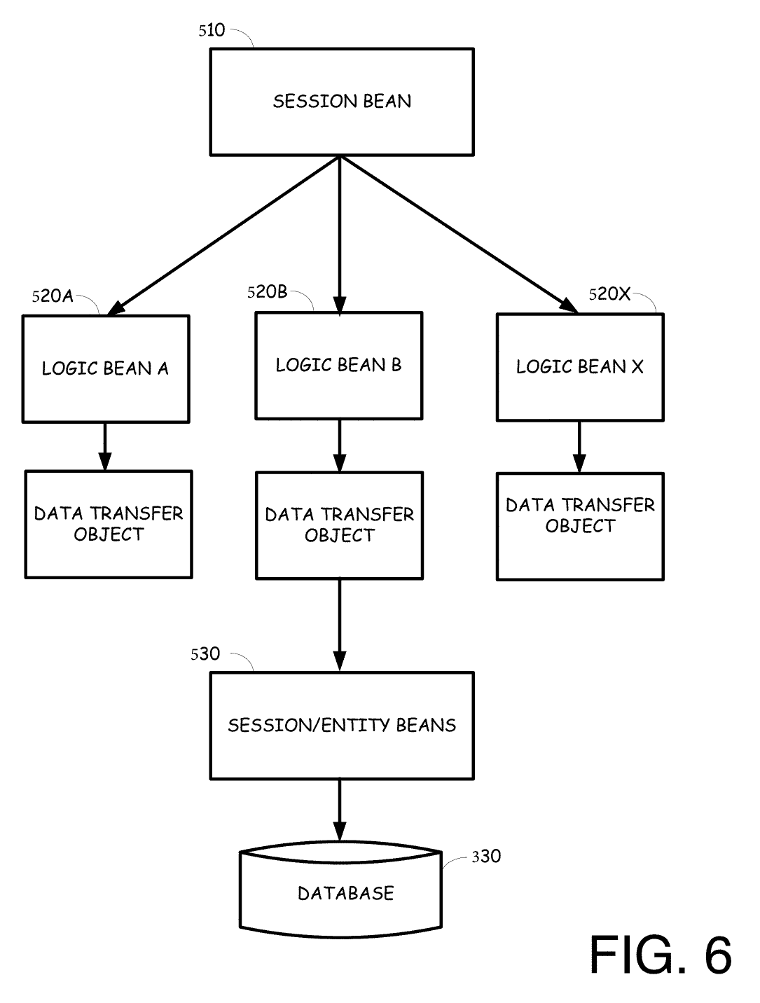

FIG. 6 is a conceptual diagram of one exemplary embodiment of an implementation of the server side logic of the exemplary web server residing in a J2EE based architecture. In particular, the server side logic of J2EE server 320 involves the servlet/session bean 510, which resides in the server 320, contains business logic and it operates in conjunction with various entity beans (LOGIC BEAN A 520A, LOGIC BEAN B 520B . . . LOGIC BEAN X 520X). The application client 310 initially loads the screen structures (such as the exemplary screen structure 400, for example) and retrieves any necessary data records from the database 330 through the server 320. Once loaded, the user can actuate various fields in the screen. When the user actuates the panels, actions local to the application client 310 may be invoked and/or actions that involve the use of the JavaBeans in the server 320 may be invoked. For instance, if the user modifies a text field, this is completely contained within the application client 310. However, if the user actuates the SAVE panel, the information is transferred to the servlet/session bean 510 which then talks to the various entity beans 520A, 520B-520X as necessary for updating the table and ultimately the server 320 uses one or more other JavaBeans 530 to update the database 330. It should be appreciated that although just one servlet/session bean 510 is illustrated, when the user actuates any action panel, such as the SAVE panel, the action may interact with any number of servlets depending on the tasks that need to be performed.

The database contains the storage for the various underlying data that is associated with the various fields, including fields that are stored along with the various tables and data (also known as logic keys). When the user activates these fields, activation data is stored along with the tables but, does not operate to modify the structure of the data in anyway other than to indicate activation. Activation records are acted upon by the client logic, which operates to interpret the data in the tables based on the state of the activation records.

As such, when it is desired to create a customization, or to add new capabilities to the system, the logic key can be defined and the underlying business logic to implement the functions associated with activation record can be created. The functions can be performed either completely in the client logic, the JavaBeans or a combination of both. For an application client oriented implementation, as the data is received from the server 320, the application client 310 operates on and renders the data in accordance with the state of activation record for the added functionality and the business logic. Likewise, as the data is modified, the application client 310 performs actions in accordance with the state of activation record for the added functionality and the business logic, which may result in local actions and/or server based actions. For a server oriented implementation, the server may include logic to operate on the data based on the state of the activation record for the added functionality. Finally, for implementations that are application client and server based, the business logic may be shared between the application client 310 and the server 320. In either case, when defining and implementing a Logic Key, additional JavaBeans, including Session Beans and Logic Beans may be necessary in order to implement the added functionality.

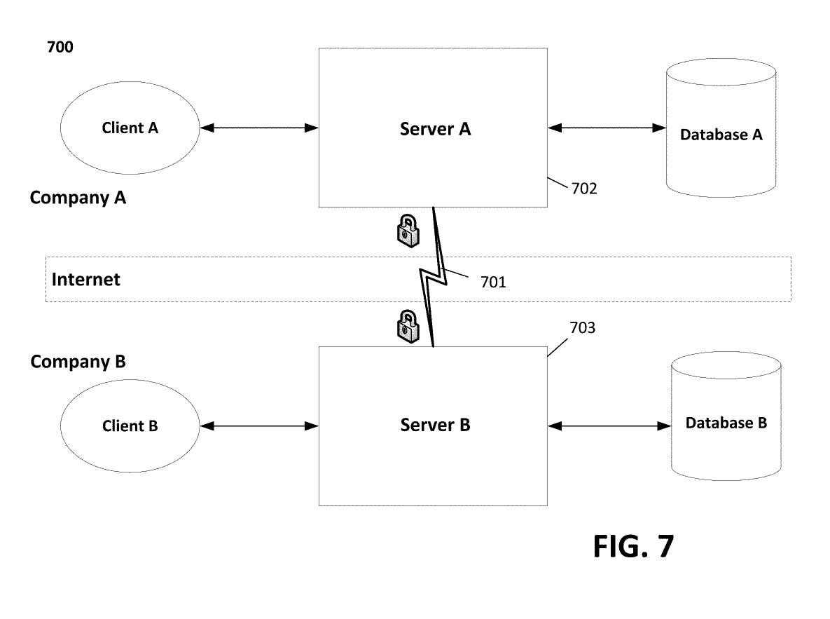

FIG. 7 is a block diagram of the exemplary use of a secure communication path between participating entities implementing the computerized accounting information system. The exemplary computer accounting information system 200 of FIG. 2 may involve the secure communication path described. Specifically, a protocol such as HTTPS can be utilized as a non-limiting example of a secure communication path. The use of this protocol provides encrypted communication and secure identification of a network web server. HTTPS connections are used in many situations in which sensitive information is being communicated. For instance, HTTPS is frequently used for payment transactions on the World Wide Web, as well as other connections in which sensitive information may be communicated. The detailed operation of HTTPS and the involvement between the various communication network layers is not addressed in detail in this description, as those of ordinary skill in the relevant art will be familiar with the technical aspects of HTTPS. As such, only a high-level overview of the technology is presented. HTTPS provides data privacy for information that is communicated between entities utilizing the application being described. For purposes of this description, FIG. 7 illustrates a secure communication path 701 between the Server A 702 of participating entity Company A and the Server B 703 of participating entity Company B.

Use of SSL server authentication allows a user to confirm a server's identity. An application that incorporates SSL-enabled software can use standard techniques of public-key cryptography to check that a server's certificate and public ID are valid and have been issued by a trusted certificate authority. Such confirmation is important—if the servers will be transmitting confidential information over the connection, the identity of the receiver should be validated prior to the transmission of the information.

It should be appreciated that the communication path between the server and client of a given entity (i.e., Server A and Client A) may be secured using HTTPS or other techniques, and that may or may not involve accessing the internet.

It should be appreciated that other techniques can be used to provide the secured transmission of data and client/server communication and authentication, and that the use of HTTPS is only one non-limiting example. For instance, closed networks, closed communication channels, static signing, manual encryption, VPNs, etc. could also be utilized.

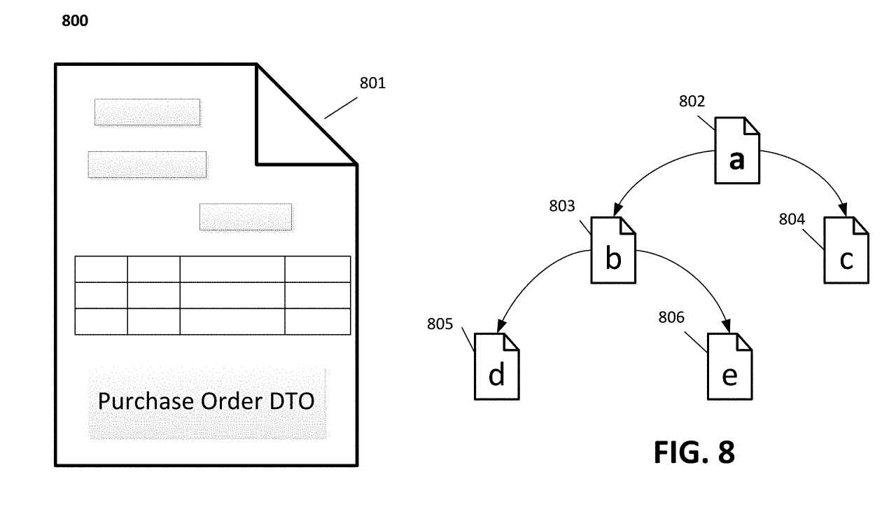

FIG. 8 is a conceptual diagram of the components of an exemplary data transfer object for a client-server object oriented architecture. The exemplary data transfer object 800 is configured to operate on the client-server application environment 300 of FIG. 3 implemented with the exemplary J2EE server 320 configuration. Object-oriented programs are based on the concept of objects that interact with each other, unlike more conventional programming methods that view a program as essentially a list of tasks to be performed. The details of object-oriented programming and the interaction between data objects and other processing functions or routines is not explained here, as those of ordinary skill in the relevant art will be familiar with the technical aspects of object-oriented programming. For the purposes of this application, an object is a self-contained piece of programming code that combines data and the processing instructions needed to manipulate it. If an object also includes the code and processing instructions needed to carry data from one location (or processing step) to another, it can be referred to as a data transfer object (DTO). As a non-limiting example, DTO 801 contains the data relating to a purchase order, the processing instructions needed to manipulate said data, and the processing instructions needed to carry said data from one location (or processing step) to another.

Objects can refer to other objects. As another non-limiting example, DTO 802(a) references objects 803(b) and 804(c). In turn, object 803(b) refers to objects 805(d) and 806(e). It should be appreciated that objects can reference other objects, regardless of whether or not any of the objects involved are DTOs. Any or all of the objects 802, 803, 804, 805, and 806 can be a data transfer object (DTO). In an exemplary embodiment of the secure data exchange technique, data relating to a given business transaction is encapsulated into a DTO that can be transmitted from the business management system of one participating entity to those of other participating entities.

It should be appreciated that a DTO is not a remote user connection between participating entities, nor does a DTO require a remote user connection to be transmitted between participating entities.

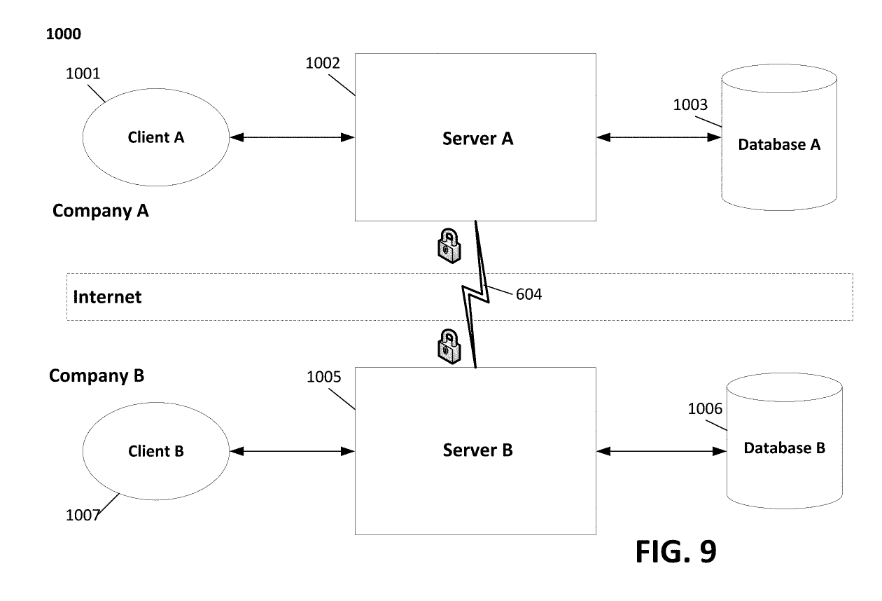

FIG. 9 is a block diagram of an exemplary embodiment of a business management system/computerized accounting information system of participating entities Company A and Company B, and the secure communication path between the two entities. In the illustrated embodiment, the business management system 1000/computerized accounting information system 200 may be a web-based or web-centric accounting and general ledger system in a client-server configuration like that described in FIGS. 2-4.

A user in Company A initiates a business transaction by creating a record—for example, a Purchase Order for ten steel widgets—in a client module associated with Client A 1001 and transmits it to Server A 1002, which saves the record in Database A 1003. Server A 1002 then encapsulates the data contained in the record into a serializable DTO, encrypts it, then transfers it over secure path 1004 to Company B's Server B 1005, where it is decrypted and saved in Database B 1006.

Entities utilizing this illustrated embodiment can easily create new records based on the data contained in a DTO. Via Client B 607, a user in Company B sees that Company A has sent a DTO, and creates a Sales Order in Client B 607 with data from Company A's DTO. The system populates the data from the DTO into the appropriate fields of the Sales Order. The user enters any additional information needed regarding the order and transmits it from Client B 1007 to Server B 1005, which saves the record to Database B 1006 and modifies the DTO to include the data from the Sales Order. In this way, all the records associated with a transaction are linked by the DTO. Server B 1005 encrypts and transfers the DTO over secure path 1004 to Server A 1002, which decrypts it and stores it in Database A 1003.

It should be appreciated that the above description explains the basic steps for creating and modifying a DTO using an exemplary embodiment of the secure data exchange technique being described. Any addition, deletion, or modification of data linked to a DTO modifies the DTO, and the newly modified DTO is automatically transmitted to the participating entities.

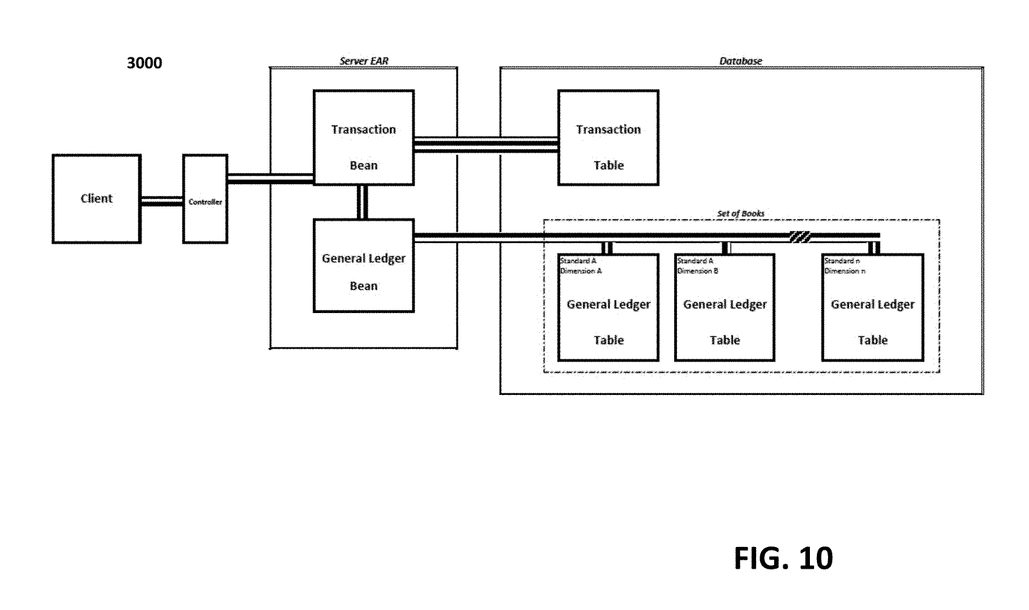

FIG. 10 is a functional block diagram of an exemplary embodiment of a computerized accounting information system. The exemplary computerized accounting information system 200 of FIG. 2 may be represented by the following multi-dimensional structure 3000. The multi-dimensional system 3000 may be implemented on a platform such as the platform 100 of FIG. 1., and may be implemented within functional environment 300 of FIG. 3. The multi-dimensional system 3000 may leverage a J2EE based architecture similar to that of FIGS. 4 and 6.

The multi-dimensional system 3000 may be designed so that the general ledger records are separate from the transaction records (payments, receipts, invoices, etc.) as far as the database architecture is concerned.

More specifically, each class of transactions (AP Payments, AR Receipts, AP Invoices, AR Invoices, AP Purchase Orders, AR Sales Orders, AR Sales Quotes, etc.) each have their own set of database tables. This disclosure references “set” because there are multiple tables for a single transaction record, as is understood by a person having ordinary skill in the art. For example, an AP Payment actually consists of 1 AP Payment Record, an unlimited number of AP Detail Records (one for each detail line in the screen table, for example), an unlimited number of Other Charges Records (these correspond to each tax, shipping, discount, etc. line), as well as any other additional tables that may pertain to additional types of concepts and process that may apply to a specific transaction (such as the recording or application of a prepayment, for example). Furthermore, supporting information for a transaction, such as that transaction's vendor or the inventory items in an order, for example, also have their own specific and separately distinct database tables.

All of these database tables are responsible for the recording of the transaction record and the associated information with that transaction. While there are many tables that correspond to the set as described, there is only one set of records for this transaction. The transaction records are not duplicated if those records exist in a multi-dimensional general ledger such as this exemplary multi-dimensional system 3000.

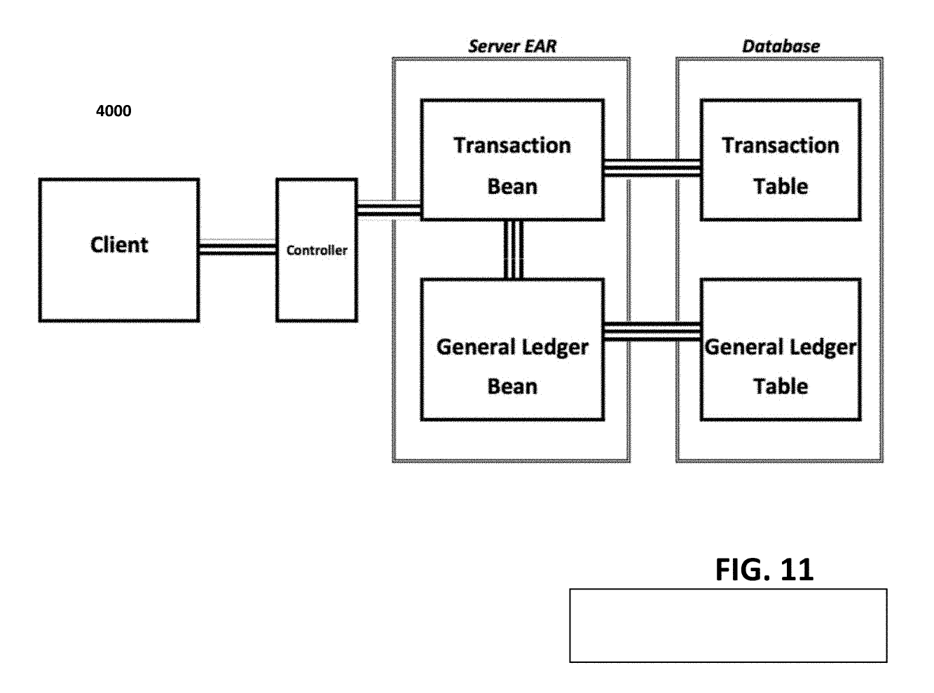

As a brief aside, and for comparison purposes, FIG. 11 is a functional block diagram of an exemplary embodiment of a computerized accounting information system represented by the following non, multi-dimensional structure 4000. The non, multi-dimensional system 4000 may be implemented on a platform such as the platform 100 of FIG. 1., and may be implemented within functional environment 300 of FIG. 3. The non, multi-dimensional system 4000 may leverage a J2EE based architecture similar to that of FIGS. 4 and 6.

Returning to FIG. 10, some exemplary differences become apparent when comparing FIG. 10 with FIG. 11; specifically, the process of recording the GL records when a transaction is created, edited, or destroyed.

As is described herein, parts of a transaction are broken out into different database tables to correspond to like data. Similarly, the general ledgers posting records are also a separate table. When a transaction is saved, edited, or deleted in a single dimension system, that transaction's transaction record tables are created, edited, or removed, and also a process is triggered to create general ledger records.

The general ledger record postings consist of their own set of tables. There is a general_ledger_entry table which is the main backbone, as well as a few ancillary tables that provide supporting functions such as tracking certain necessary calculations. Creations, edits, or deletions of transaction records will cause necessary modifications to this posting data, but they are distinctly separate systems within the same database. Essentially, to stay in sync, the two systems facilitate the communication link between the two. This logic is maintained within a general ledger Posting Bean that contains specific logic for each transaction type and each possible transaction scenario. The coding of the logic determines how the general ledger posting occurs and is coded such to mimic that which the accountant would do with a physical set of books.

Everything described thus far may apply to a single dimension scenario (e.g., non, multi-dimensional structure 4000), however a multi-dimensional system (e.g., multi-dimensional structure 3000) is simply an expansion of this architecture. In a multi dimensional system, everything described thus far exists as a single dimension, additional dimensions are implemented by supplying (per additional dimension) an additional set of general ledger entry (and supporting calculation) database tables, and an additional general ledger Posting Bean to handle transactions as they would be handled under the accounting rules particular to the additional dimension. When a transaction is saved, edited, or deleted, an infinite (well limited by hardware, of course) number of general ledger posting processes may be triggered, one for each available dimension. Each general ledger posting process records its own set of records in its own General Ledger Entry table as dictated by the logic coded in its particular General Ledger Posting Bean. Regardless of how many GL posting processes occur, and regardless of how many sets of GL entries are created for these processes, there still only exists one set of transaction data (the payment table record, the details table records, the other charges table records, etc.).

The strengths of a multi-dimensional system like multi-dimensional structure 3000 are realized in the reporting. Financial reports produced from the multi-dimensional structure 3000 work off of the previously described general ledger tables. The specification of a dimension is a parameter supplied before running the report. In a single dimensional system like non, multi-dimensional structure 4000, there is only one option (and thus the user is not presented with a choice). In a multi-dimensional system, the user may select which dimension they wish to display data for, and then the report will gather information from the corresponding set of GL tables for that dimension. Any data that may need to be retrieved for the transactions themselves (such as an invoice number, vendor paid, etc.) is retrieved from the set of transaction data tables. Again, as is described herein, there is only one set of transaction data, and those same tables are accessed regardless of which dimension has been chosen to display report data for.

As such, one exemplary embodiment of a computerized accounting information system based on FIG. 10 allows the accountant to avoid using spreadsheets, having to set up the same entity in various different sets of book, and having to deal with the implications of tracking these various accounting standards. Instead, the computerized accounting information system leverages only one set of books, and allows that one set of books to be multi-dimensional. This allows the user of the system to record a transaction(s), one time, in multiple dimensions.

This also allows the user of the system to perform experimentation for purely internal and/or managerial purposes. For example, say a project manager indicates that he/she wants to account for a transaction or series of transactions or particular grouping of transactions (for a particular internal and/or managerial purposes), then the system would allow that user to track and establish the protocol as desired. The system allows the user to have a vast amount of flexibility to track, audit, analyze, and report financial accounting data.

Further, one exemplary embodiment of a computerized accounting information system based on FIG. 10 comprises reconciliation criteria/function, such that, when the system is being used to compare two or more dimensions, the system will facilitate an auditor (internal or external), or manager, or government investigator, to reconcile the differences between the dimensions, see how they manifest in the data, and see exactly where the differences rest.

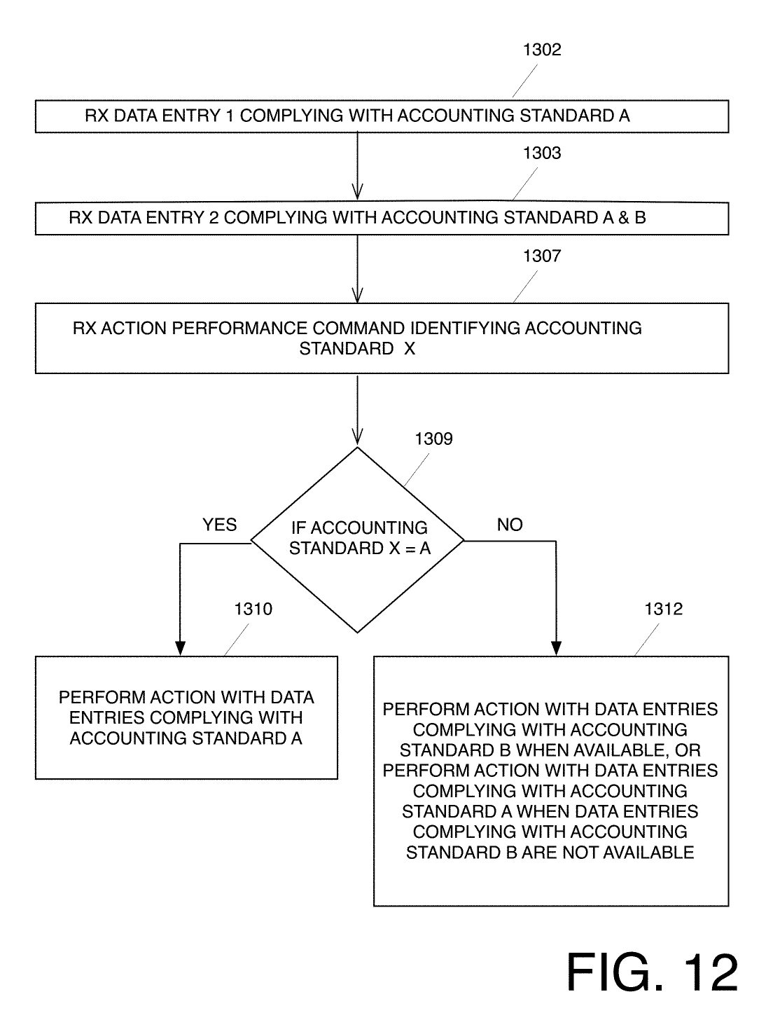

FIG. 12 is a flowchart diagram illustrating actions that may be implemented by some embodiments of the computerized accounting information system, or that may be included within a method of processing accounting data. While these actions may be presented in particular order, a person having ordinary skill in the art understands that this order is merely for ease of description and, therefore, is not intended as a limitation.

Initially, data for a first type of data field (e.g., debit, credit, cash-flow in, cash-flow out, account receivable, liability, equity asset, capital asset, cash, debt, tax) is entered into the computerized accounting information system. This can be done in a variety of manners such as reading data from a file, receiving a download of data, receiving individual data inputs, or any other manners known by one having ordinary skill in the art. Overall, a data entry for a first type of data field is received wherein the data complies with at least a default accounting standard, “A” (1302). A data entry for a second type of data field is also received wherein the data complies with the default accounting standard “A” and at least one other accounting standard “B” (1303). Multiple other data entries may also be received, and these other data entries may each comply with a variety of permutations of accounting standards for a particular type of data field. In one class of embodiments, all the data entries at least comply with the default accounting standard. However, other classes of embodiments may not impose this restriction.

Any received data entry may be stored in the database 228 for later access or they may be received and used without storage. Therefore, regardless of whether the data entries will be stored or received-used-discarded, Table 1a is intended to depict, as an exemplary embodiment, how received data entries may be compiled and organized for use directly from the end-user or pulled from a database. For purposes of Table 1a, the “Data Entry ID” identifier, e.g., 1, 2, 3, is intended to differentiate between different data entries. The triplet letter designation, e.g., XXX, YYY, is intended to differentiate between the different types of data fields. The “Accounting Standard” identifier, e.g., [none], ′, ″, on the triplet letter designation is intended to differentiate between the different accounting standards by which the data entries may comply.

TABLE 1a

| Data | Accounting Standard | | |
|---|---|---|---|
| Entry ID | A | B | C |
| 1 | XXX | | |
| 2 | YYY | Y′Y′Y′ | |
| 3 | ZZZ | Z′Z′Z′ | |

Therefore, Table 1a depicts that “Data Entry ID” 1 for a first type of data field (e.g., cash-flow out) was received, and that this data entry complied with the “A” accounting standard. Table 1a also depicts that “Data Entry ID” 2 for a second type of data field was received (e.g., cash-flow in) and this data entry complied with the “A” accounting standard and at least one other accounting standard; specifically, the “B” accounting standard. Table 1a also depicts that “Data Entry ID” 3 for a third type of data field was received (e.g., account receivable) and this data entry complied with the “A” accounting standard and at least one other accounting standard; specifically, the “B” accounting standard.

After the data has been entered into the system, a command to perform an action is received. The command may also identify one or more accounting standards for performance of the action or, in the absence thereof, the default accounting standard may be assumed. Other information or instructions for performance of the action, or the like, may also be included with the command (1307).

Thus, the command is basically a request to perform an action. The action is to be influenced or based, at least in part, on the identified accounting standard or standards. If the identified accounting standard is the “A” accounting standard (1309), then the action of the command is performed with one or more data entries that comply with the “A” accounting standard (1310). However, if the identified accounting standard is the “B” accounting standard (1309), then the action of the command is performed with one or more data entries that comply with the “B” accounting standard, if available (1312). If not available, then the action of the command is performed with one or more data entries that comply with the “A” accounting standard for each of the one or more data entries that is unavailable in the “B” accounting standard (1312).

It should be appreciated that Table 1a illustrates a simplified structure and that, in practice, the structure may be more complex in nature. For example, a data entry for a type of data field may be more complex than merely an entry into one “field” as seemingly illustrated by the triplet letter designation in Table 1a. Instead, the data entry may be into one or more fields represented by the triplet letter designation; the one or more fields based, at least in part, on the applicable accounting standard characterizing that specific data entry. For instance, consider a situation in which a law firm receives a single check from a specific client for a specific legal service provided (i.e. one specific cash-flow in). This specific check constitutes one specific data entry, for example, “Data Entry ID” 2 of Table 1a. If the applicable accounting standard characterizing “Data Entry ID” 2 is the “A” accounting standard, a portion of the check total amount may be allocated to a variety of fields represented by the triplet letter designation YYY: one third to “over head cost recoupment,” one third to “origination fee allocation” and one third to “firm income.” However, if the applicable accounting standard characterizing “Data Entry ID” 2 is the “B” accounting standard, the entire check total amount may be allocated to one field represented by the triplet letter designation YYY: “firm income.” Similarly, if the applicable accounting standard characterizing “Data Entry ID” 2 is the “C” accounting standard, the entire check total amount may be allocated to a variety of fields represented by the triplet letter designation YYY: one fourth to “business development cost recoupment,” one fourth to “origination fee allocation,” one fourth to “management cost recoupment” and one fourth to “firm income.”

Table 1b depicts, as an exemplary embodiment, how received data entries such as those of the law firm example may be compiled and organized for use directly from the end-user or pulled from a database. For purposes of Table 1b, the “Field ID” identifier, e.g., 1, 2, 3, is intended to differentiate between different fields in which data may be entered for the specific “Data Entry ID” 2 depending on the applicable accounting standard. Specifically, “Field ID” 1 is “over head cost recoupment,” “Field ID” 2 is “origination fee allocation,” “Field ID” 3 is “firm income,” “Field ID” 4 is “business development cost recoupment” and “Field ID” 5 is “management cost recoupment.”

TABLE 1b

| | Data Entry ID 2 | | |
|---|---|---|---|
| FIELD ID | YYY | Y′Y′Y′ | Y″Y″Y″ |
| 1 | ⅓ | — | — |
| 2 | ⅓ | — | ¼ |
| 3 | ⅓ | 1/1 | ¼ |
| 4 | — | — | ¼ |
| 5 | — | — | ¼ |

Therefore, Table 1b depicts the various ways in which the total value of the client check to the law firm, “Data Entry ID” 2, may have been entered/distributed into the computerized accounting information system. If “Data Entry ID” 2 complied with the “A” accounting standard, then a data entry for Field ID” 1, “Field ID” 2 and “Field ID” 3 was received. If “Data Entry ID” 2 complied with the “B” accounting standard, then a data entry for Field ID” 3 was received. If “Data Entry ID” 2 complied with the “C” accounting standard, then a data entry for Field ID” 2, “Field ID” 3, “Field ID” 4 and “Field ID” 5 was received.

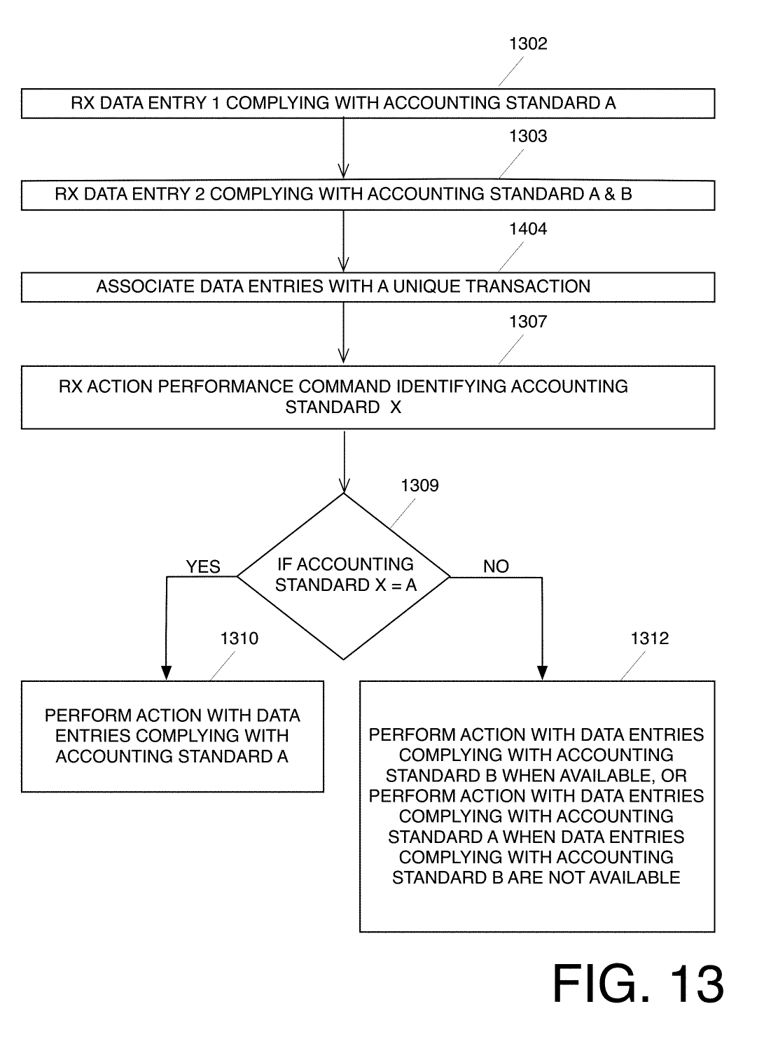

FIG. 13 is a flowchart diagram illustrating actions that may be implemented by some embodiments of the computerized accounting information system, or that may be included within a method of processing accounting data. Specifically, FIG. 13 is the flowchart diagram of FIG. 12 with an additional action.

As is described above, the data entries may be labeled, categorized and/or organized into individual fields of data (e.g., debit, credit, cash-flow in, cash-flow out, account receivable, liability, equity asset, capital asset, cash, debt, tax). The data entries of different individual types of fields of data may also be aggregated into over-arching transactions (e.g., the debits and credits involved with the sale of an asset as part of one specific transaction as distinct from the debits and credits involved with the acquisition of an asset as part of an entirely distinct transaction). Therefore, multiple data entries for the same type of data field may be received by the computerized accounting information system for various different unique transactions.

For instance, consider the previously described situation wherein the law firm received a single check from a specific client for a specific legal service provided (i.e. one specific cash-flow in). It is possible that this one specific cash-flow in (one type of data field) may be part of a larger over-arching transaction that involves certain cash-flows out, certain accounts receivable owed by the client to the law firm, etc. While the specific check may constitute one specific data entry, for example “Data Entry ID” 2 of Table 1a, the account receivable owed by the client to the law firm may constitute another specific data entry, for example “Data Entry ID” 3 of Table 1a. It is possible that these two data entries may be received together as one aggregate unique transactional data entry representing the larger financial transactions between the law firm and the client. It also possible that an entirely different client has a similar accounting transactions with the law firm that similarly involves that same types of data fields, e.g., a cash-flow into the firm, in terms of a received payment check, and an account receivable owed by this client to the firm. Like the first client, it is possible that the larger over-arching financial transaction may be received as one aggregate unique transactional data entry representing the larger financial transaction between the law firm and this second client.

As a result, in FIG. 13, a data entry for a unique transaction into the computerized accounting information system may not merely encompass data for one type of data field, e.g., only XXX or only YYY or only ZZZ; instead, a data entry may encompass data for multiple types of data fields, e.g., XXX and YYY and/or ZZZ. Therefore, in order to distinguish between sub-categories of data in the received data entries, e.g., “Data Entry ID” 1, “Data Entry ID” 2, the data entries were associated with the unique transaction (1404).

Table 2 depicts, as an exemplary embodiment, how received data entries for unique transactions may be compiled and organized for use. For purposes of Table 2, the triplet letter designation, e.g., ααα, βββ, is intended to differentiate between different unique transactions. As a result, Table 2's triplet greek letter designation may encompass one or more sub-categories of data for any type of data field, e.g., XXX, YYY, ZZZ. Like Table 1a, the “Accounting Standard” identifier, e.g., [none], ′, ″, on the triplet letter designation is intended to differentiate between the different accounting standards by which the data entries, and any of their sub-categories of data, may comply.

TABLE 2

| Data | Accounting Standard | | |
|---|---|---|---|
| Entry ID | A | B | C |
| 1 | ααα | | |
| 2 | βββ | β′β′β | |

Therefore, Table 2 depicts that “Data Entry ID” 1 for the ααα unique transaction (e.g., the transaction related to the first law firm client) was received and that this data entry, and all of its sub-categories of data, complied with the “A” accounting standard. Table 2 also depicts that the “Data Entry ID” 2 for the βββ (e.g., the transaction related to the second law firm client) was received and that this data entry, and all of its sub-categories of data, complied with the “A” accounting standard and the “B” accounting standard. One having ordinary skill in the art should understand that the description of Table 2 is equally applicable to data entries for unique transactions and/or any of their sub-categories of data.

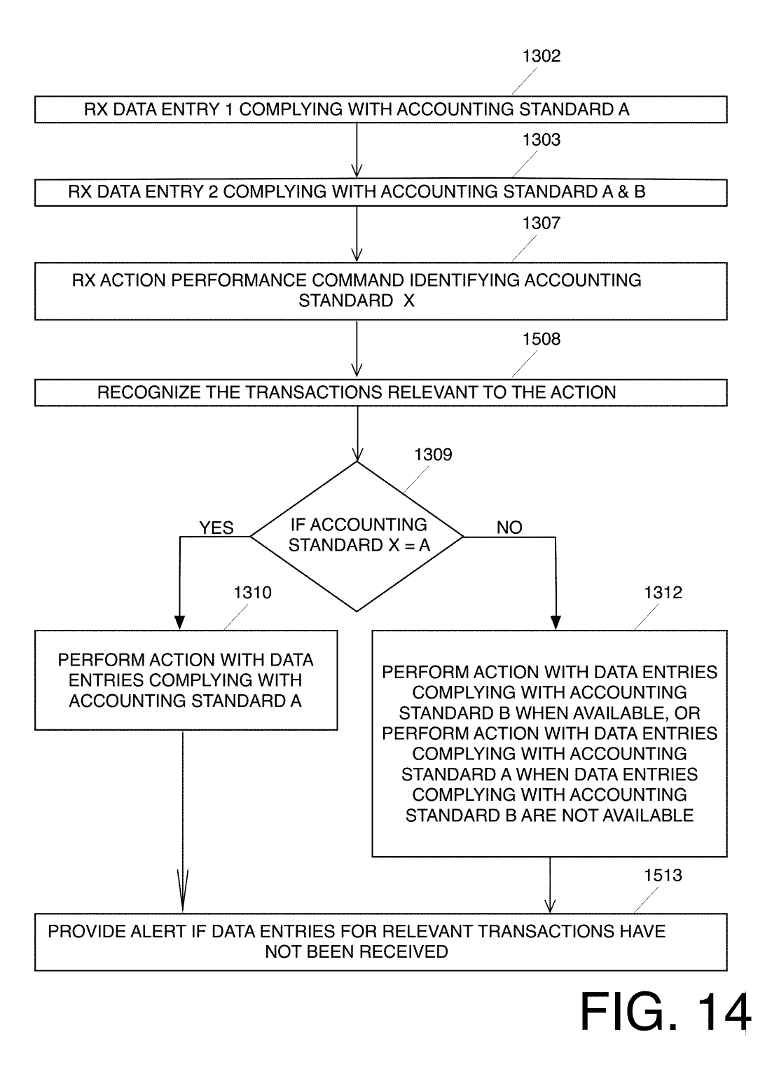

FIG. 14 is a flowchart diagram illustrating actions that may be implemented in some embodiments of the computerized accounting information system, or that may be included within a method of processing accounting data. Specifically, FIG. 14 is the flowchart diagram of FIG. 12 with additional actions.

As is described above, because data entries may be labeled, categorized and/or organized into sub-fields and then aggregated into over-arching transactions, it is envisioned that it is possible to leverage a smart logic to selectively search, filter and/or compile those sub-fields and to recognize those transactions most relevant to the identified action and accounting standard in the received command. Therefore, as is illustrated in FIG. 5, each data field type is a unique transaction and the unique transactions relevant to performing the action are recognized (1508). If a data entry has not been received for one or more relevant transactions, an alert indicator is provided that, as an exemplary embodiment, notifies the end-user that additional data may be required (1513).

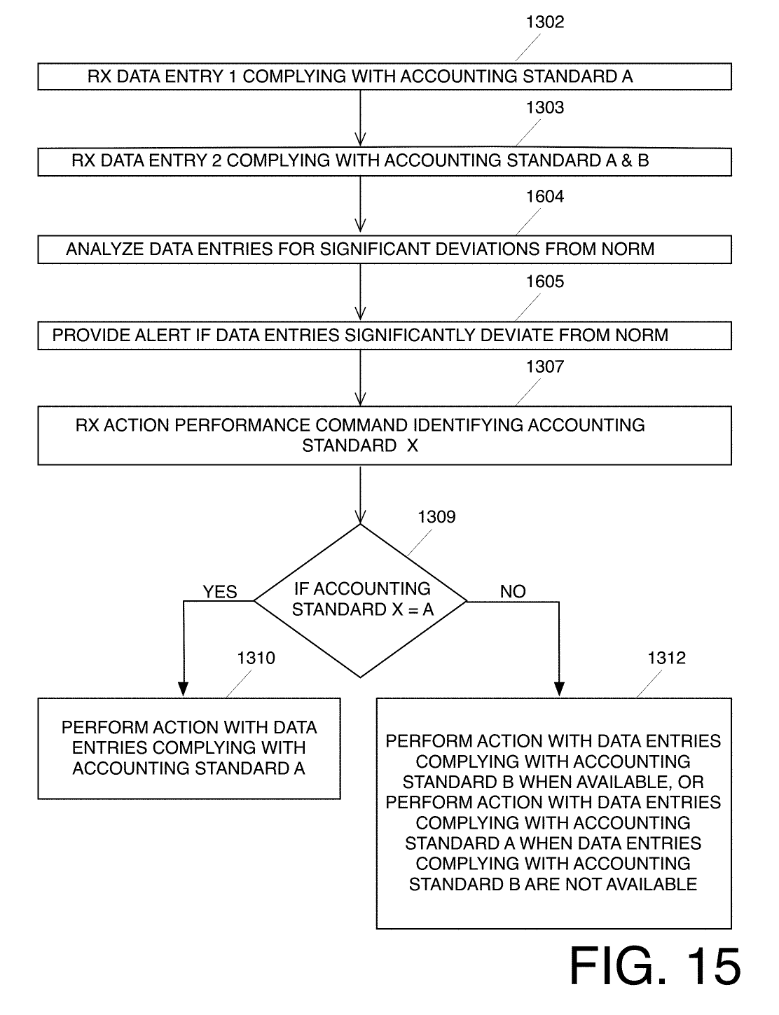

FIG. 15 is a flowchart diagram illustrating actions that may be implemented in some embodiments of the computerized accounting information system, or that may be included within a method of processing accounting data. Specifically, FIG. 15 is the flowchart diagram of FIG. 12 with additional actions.

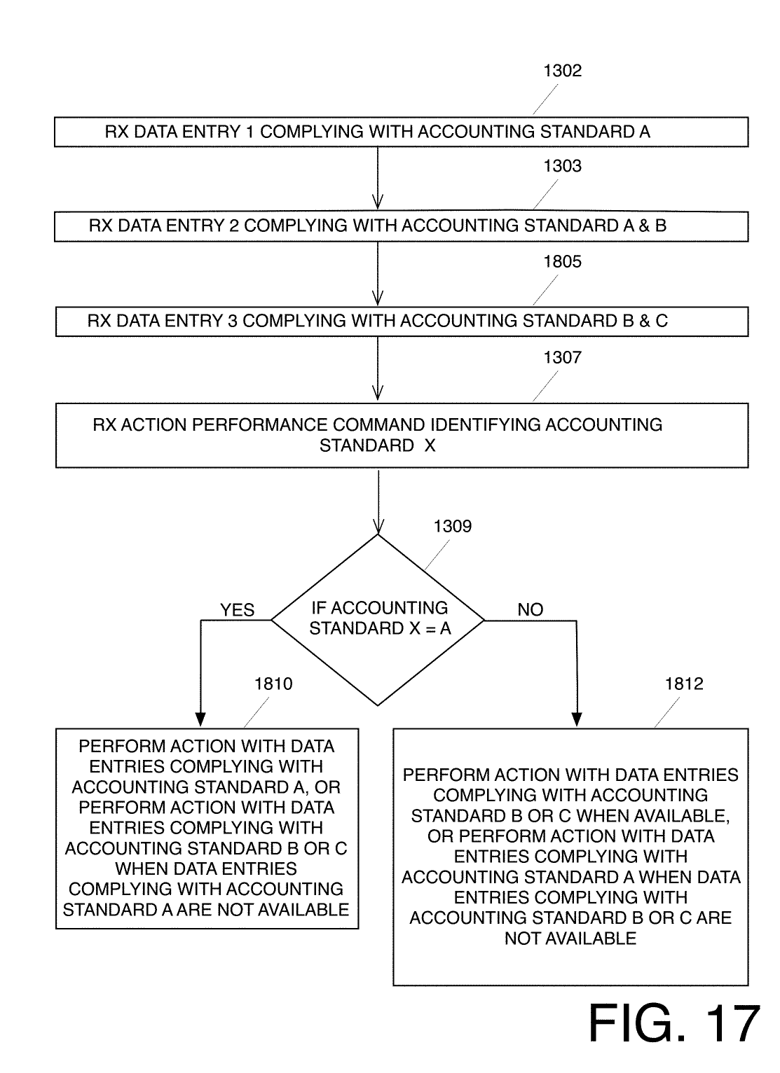

As is described above, because data entries may be analyzed for significant deviations from what would be expected as a consistent data entry under a particular accounting standard, it is possible to infer/extrapolate/compute this expected data entry based, at least in part, on a sample of related and relevant data entries under similar transactions, or under similar sub-fields across a variety of transactions. Therefore, as is illustrated in FIG. 17, the data entries are analyzed for significant deviations from an expected data entry based, at least in part, on at least one of a group comprising the type of data field, the “A” accounting standard and the “B” accounting standard (1604). If the data entries significantly deviate from the expected data entry, an alert indicator is provided (1605). Processing of the action may then be halted until the situation is remedied, or the action may continue and the computerized accounting information system may simply flag the data entry as potentially suspect.

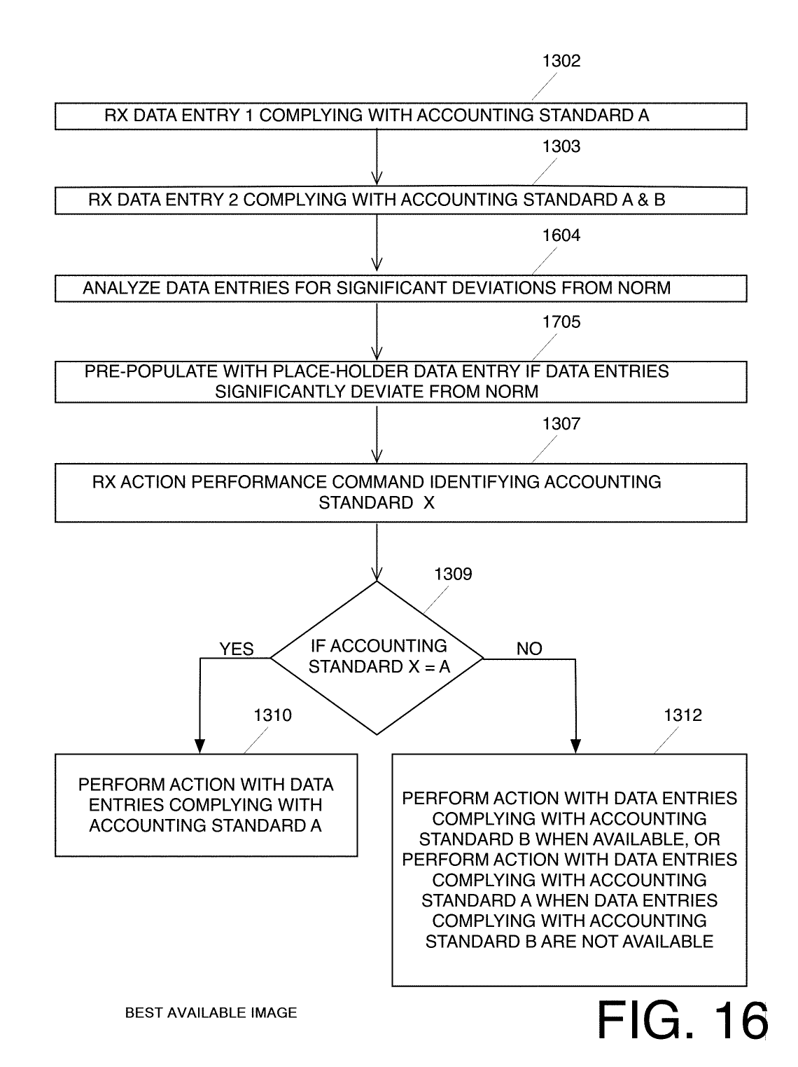

FIG. 16 is a flowchart diagram illustrating actions that may be implemented by the various embodiments of the computerized accounting information system, or that may be included within a method of processing accounting data. Specifically, FIG. 16 is the flowchart diagram of FIG. 15 with an additional action in place of 1605.

As described above, instead of merely providing a significant deviation alert indicator, it may be more helpful to leverage the obtained expected data entry such that a specific data entry value suggestion is provided. Therefore, as is illustrated in FIG. 16, if the data entries significantly deviate from the expected data entry, the type of data field may be prepopulated with a place holder data entry (1705). In another exemplary embodiment of FIG. 16, the type of data field is not prepopulated, but instead, emphasized with a suggestion indicator allowing for replacement of any previously entered data entry with the suggested place holder data entry (1705). In still another exemplary embodiment of FIG. 16, the type of data field is only emphasized with a suggestion indicator if the previously entered data entry is sufficiently statistically different from the place holder data entry (1705). One having ordinary skill in the art recognizes that the preceding embodiments are merely some of the possible variations available for leveraging the obtained expected data entry such that a specific data entry value suggestion may be provided. Therefore, the various embodiments are not limited to any particular technique.

FIG. 17 is a flowchart diagram illustrating actions that may be implemented by the various embodiments of the computerized accounting information system, or that may be included within a method of processing accounting data. Specifically, FIG. 17 is the flowchart diagram of FIG. 12 with additional actions including one in place of 1310 and 1312.

In the illustrated embodiment, a data entry for a third type of data field is received (1805). As is illustrated, this data entry does not comply with the “A” accounting standard; however, it does comply with at least one other accounting standard “B.” Table 3 depicts, as an exemplary embodiment, how received data entries may be compiled and organized for use based on FIG. 17.

TABLE 3

| Data | Accounting Standard | | |
|---|---|---|---|
| Entry ID | A | B | C |
| 1 | XXX | | |
| 2 | YYY | Y′Y′Y′ | |
| 3 | | Z′Z′Z′ | Z″Z″Z″ |

Therefore, Table 3, in contrast to Table 1, depicts, as an exemplary embodiment, that a data entry for the ZZZ type of data field was received, and that this data entry complied with the “B” accounting standard and the “C” accounting standard but not the “A” accounting standard.

After the data has been entered into the system, if the identified accounting standard is the “A” accounting standard (1309), then the action of the command is performed with one or more data entries that comply with the “A” accounting standard, or, if a data entry is needed for performance of the action but it does not comply with the “A” accounting standard, then data entries complying with any of the other accounting standards is used (1810). However, if the identified accounting standard is the “B” accounting standard (1309), then the action of the command is performed with one or more data entries that comply with the “B” accounting standard, if available (1812). If not available, then the action of the command is performed with one or more data entries that comply with the “A” accounting standard for each of the one or more data entries that is unavailable in the “B” accounting standard (1812). If not available, then the action of the command is performed with one or more data entries that comply with the “C” accounting standard for each of the one or more data entries that is unavailable in the “A” accounting standard and the “B” accounting standard (1812). Similarly, if the identified accounting standard is the “C” accounting standard (1309), then the action of the command is performed with one or more data entries that comply with the “C” accounting standard, if available (1812). If not available, then the action of the command is performed with one or more data entries that comply with the “A” accounting standard for each of the one or more data entries that is unavailable in the “C” accounting standard (1812). If not available, then the action of the command is performed with one or more data entries that comply with the “C” accounting standard for each of the one or more data entries that is unavailable in the “A” accounting standard and the “C” accounting standard (1812).

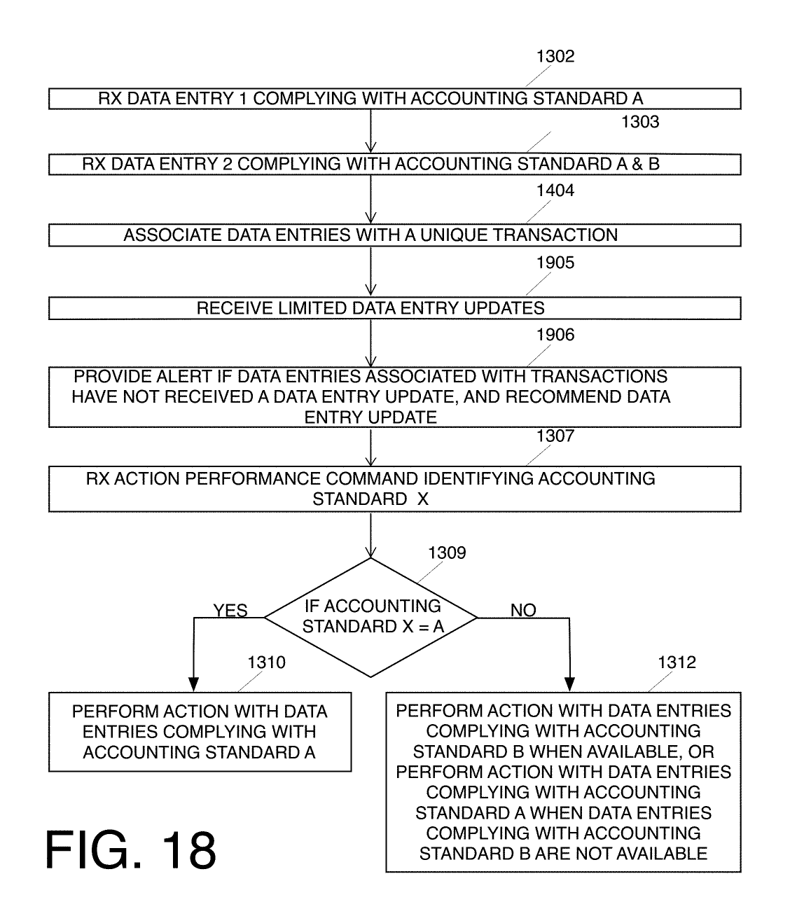

FIG. 18 is a flowchart diagram illustrating actions that may be implemented by the various embodiments of the computerized accounting information system of the present disclosure, or that may be included within a method of processing accounting data. Specifically, FIG. 18 is the flowchart diagram of FIG. 13 with additional actions.

In the illustrated embodiment, at least one limited data entry update for one of the previously received data entries is received (1905). The limited data entry updates may comply only with the default accounting standard, “A,” of the previously received data entries or may comply with the “B” accounting standard. These limited data entry updates may fully update an entire unique transaction for either the “A” accounting standard or the “B” accounting standard. On the other hand, these limited data entry updates may simply update sub-components of the unique transactions for either the “A” accounting standard or the “B” accounting standard. Therefore, if any sub-component data entries associated with a unique transaction, or if any entire unique transaction data entry, has not been updated for either the “A” accounting standard or the “B” accounting standard, an alert indicator is provided that recommends further data entry updates (1906). Processing of the action may then be halted until the situation is remedied, or the action may continue and the computerized accounting information system may simply flag the data entry as potentially suspect.

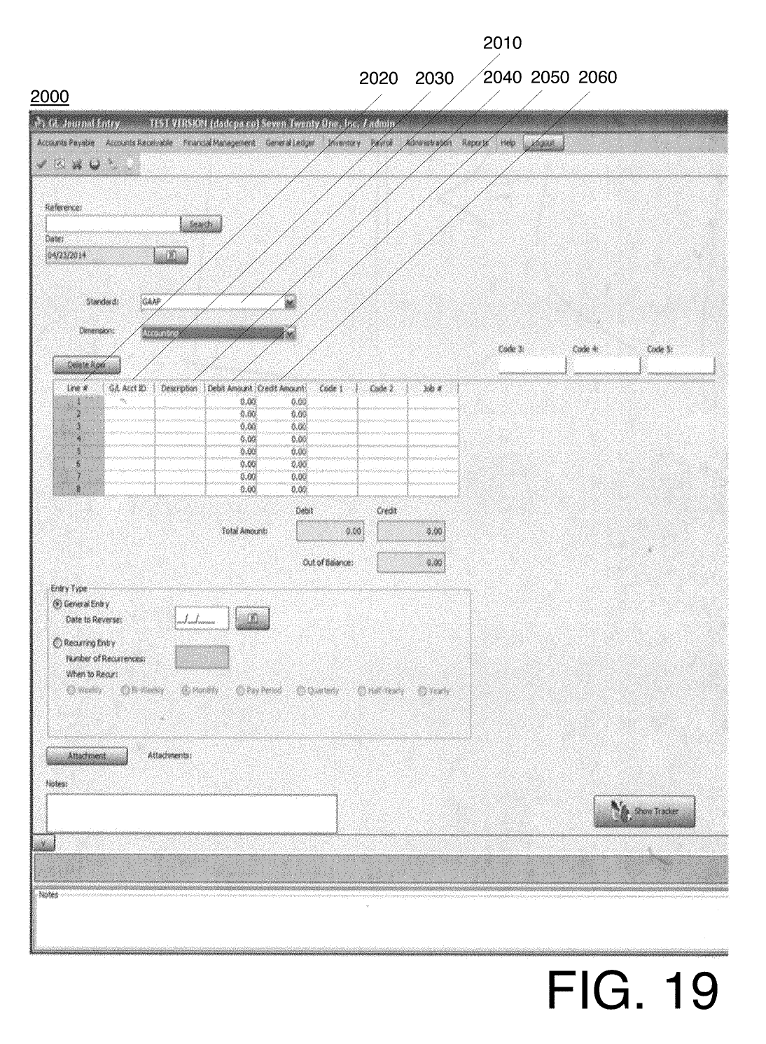

FIG. 19 is a screenshot of one exemplary embodiment of an end-user interface 2000 to the computerized accounting information system as it might appear to an end-user. The end-user interface 2000 may be incorporated into the data entry module 222, either directly or through the network 220, to receive data entries from the end-user; the data entries to be digitally stored, organized and/or analyzed by computerized accounting information system 200. Therefore, the end-user interface 2000 may appear on the end-user platform 205, as described in FIG. 2, when the end-user platform remotely accesses the data entry module 222 hosted on the platform 100 (e.g., as an online application stored in the cloud, or as a webpage stored on a remote server). The end-user interface 1000 may also appear on the end-user platform 205, as described in FIG. 2, because the data entry module 222 is implemented on the end-user platform 205 as a packaged software bundle, or any downloadable piece of software known to one having ordinary skill in the art. Of course, it is envisioned that the end-user interface 2000 may take various different organizational, graphical and design forms.

In one exemplary embodiment, the end-user interface 2000 functions, at least in part, as the interface where an end-user enters data entries to be transmitted and received by the data entry module 222 and the processing module 226. The end-user interface 2000 may also function, at least in part, as the interface where an end-user enters a command to be transmitted and received by the command receiving module 224 and the processing module 226. Consequently, the end-user interface 2000 is configured to provide the end-user with the ability to label, categorize and/or organize data entries into fields and to aggregate data entries of different fields into over-arching transactions.

In the illustrated embodiment, the element 2010 represents one exemplary embodiment of a drop down menu wherein an end-user may select the accounting standard by which the data entries are characterized. The element 2020 represents one column for differentiating the different data entries or the different sub-components of a unique transaction. The element 2030 represents one column for differentiating the different data entries into various unique transactions, or into other grouping categories known to one having ordinary skill in the art. Therefore, the element 2030 represents one embodiment of how a plurality of disparate data entries may be organized and categorized by the end-user. It is with this additional information that the data entries may be leveraged, at least in part, for some of the actions described more thoroughly in FIGS. 12-18.

The element 2040 represents one column for including exemplary judgment characterization information to be associated and, in certain embodiments, stored with the empirical information that is primarily leveraged by the computerized accounting information system 200. As is described more thoroughly above, financial accounting data may be comprised of empirical information (e.g., monetary values and tax percentages) and exemplary judgment characterizations related to the accounting standard applied to the accounting data by the end-user. Because an end-user entering data for a specific financial entity must generally follow a specific accounting standard, the same empirical information making up the data entry may be characterized differently by the end-user depending on the particular accounting standard being followed. Therefore, the element 2040 provides an end-user with an information entry point wherein it may record the rational behind the judgment characterizations for each specific data entry under a specific accounting standard at a particular point in time. This may then be readily accessed by the end-user and, in certain embodiments, leveraged by the computerized accounting information system 200 to perform any of the actions described in FIGS. 12-18. As a result, the element 2040 alongside the storing, organizing and analyzing capabilities of the computerized accounting information system 200, may benefits the end-user by substantially eliminating the need for different and discrete data management software records for each accounting standard.

As is understood by one having ordinary skill in the art, the element 2050 and the element 2060 represent standard accounting information data columns for debits and credits to supplant the need for positive and negative integers. Of course, various other columns and organizational elements may be included in the end-user interface 2000. Therefore, the various embodiments are not limited to any particular form or design.

While illustrative embodiments of a computerized accounting information system and a method of processing accounting data have been described in detail herein, it is to be understood that the inventive concepts may be otherwise variously embodied and employed. The appended claims are intended to be construed to include such variations except insofar as limited by the prior art. Possible variations, as described throughout this disclosure, are not to be regarded as a departure from the spirit and scope of the invention. All such possible variations, as would be obvious to one skilled in the art, are intended to be included within the scope of the preceding disclosure and the following claims.

It is understood that any variations of the features of the system and method described in the description section falls within the scope of the invention. There can be many embodiments of this invention as witnessed in some of the figures, and the discussions of them. Not all embodiments of a computerized accounting information system and a method of processing accounting data that would fall within the scope of the claims are necessarily represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In the description and claims the words of the present application, each of “program”, “function” and “module” are used interchangeably. Anything designated as a program, function or module may be a stand-alone entity or a specialized module. A program, function or a module may be modular or have modular aspects allowing it to be easily removed and replaced with another similar unit or module. Each program, function or module may be any one of, or any combination of, software, hardware, and/or firmware. Software of a logical module may be embodied on a computer readable medium such as a read/write hard disc, CDROM, Flash memory, ROM, or other memory or storage, etc. In order to execute a certain task a software program may be loaded to an appropriate processor as needed.

The various embodiments have been described using detailed descriptions of the embodiments, as well as features, aspects, etc. thereof. The various embodiments are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described, and embodiments of the present invention comprising different combinations of features as noted in the described embodiments, will occur to persons with ordinary skill in the art.

It will be appreciated by persons with ordinary skill in the art that the present invention is not limited by what has been particularly shown and described herein above. Rather the scope of the invention is defined by the claims that follow.

What is claimed is:

1. A method of processing, via a conceptual accounting basis, data in which individual data entries for a transaction are entered in compliance with a default set of accounting objectives and, optionally, one or more other sets of accounting objectives, and in which individual data entries are stored and managed in digital general ledgers on a client-server database, the method comprising the steps of:
receiving, at the server from the client, a first data entry related to a corresponding transaction, wherein the data entry complies with a default set of accounting objectives, and wherein the data entry necessitates an update to a transaction table and a first digital general ledger accessible to the server;
receiving, at the server from the client, a second data entry related to the corresponding transaction, wherein the data entry complies with the default set of accounting objectives and one other set of accounting objectives, and wherein the data entry necessitates an update to the transaction table, the first digital general ledger, and a second digital general ledger, the second digital general ledger also accessible to the server; and
receiving a command to perform an action, the command identifying a set of accounting objectives;
if the identified set of accounting objectives is the default set of accounting objectives then performing the action utilizing one or more data entries that comply with the default set of accounting objectives; and
if the identified set of accounting objectives is the non-default set of accounting objectives then performing the action utilizing one or more data entries that comply with the non-default set of accounting objectives, if available, otherwise utilizing a data entry that complies with the default set of accounting objectives for each of the one or more data entries that is unavailable in the non-default set of accounting objectives;
wherein the first digital general ledger is dedicated to the default set of accounting objectives, and the second digital general ledger is dedicated to the one other set of accounting objectives;
wherein the first digital general ledger and the second digital general ledger encompass one unified set of books for the corresponding transaction;
wherein the one unified set of books is associated with the transaction table for the corresponding transaction.

2. The method of processing data of claim 1, the method additionally comprising the steps of:
receiving, at the server from the client, a third data entry related to the corresponding transaction, wherein the data entry complies with the one other set of accounting objectives but not the default set of accounting objectives, and wherein the data entry necessitates an update to the transaction table and the second digital general ledger; and
when performing the action step, if the identified set of accounting objectives is the default set of accounting objectives then performing the action step utilizing one or more data entries that comply with the default set of accounting objectives, if available, otherwise utilizing a data entry that complies with the one other set of accounting objectives.

3. The method of processing data of claim 1, wherein the action step is at least one of a group comprising generating a report, generating a tax return, and generating a financial statement.

4. A system for storing and managing, via a conceptual accounting basis, digital general ledgers, wherein individual data entries for a transaction are in compliance with a first set of accounting objectives and, optionally, in compliance with one or more other disparate sets of accounting objectives, the system comprising:
a database;
a client; and
a server built on an architecture comprising:
a memory element; and
a processor communicatively coupled to the memory element, the database, and the client, the processor, in response to executing program instructions contained in the memory element, being configured to:
receive a data entry related to a corresponding transaction, wherein the data entry complies with a default set of accounting objectives, and necessitates an update to a transaction table and a first digital general ledger stored, at least in part, on the database, the first digital general ledger dedicated to the default set of accounting objectives;
receiving a data entry related to the corresponding transaction, wherein the data entry complies with the default set of accounting objectives and one other set of accounting objectives, and necessitates an update to the transaction table, the first digital general ledger, and a second digital general ledger, the second digital general ledger stored, at least in part, on the database and dedicated to the one other set of accounting objectives; and
receive a command to perform an action, the command identifying a set of accounting objectives; and
perform the action based, at least in part, on the identified set of accounting objectives such that:
if the identified set of accounting objectives is the default set of accounting objectives then the processor utilizes one or more data entries that comply with the default set of accounting objectives; and
if the identified set of accounting objectives is the non-default set of accounting objectives then the processor utilizes one or more data entries that comply with the non-default set of accounting objectives, if available, otherwise the processor utilizes data entries that comply with the default set of accounting objectives for each of the one or more data entries that is unavailable in the non-default set of accounting objectives;
wherein the first digital general ledger and the second digital general ledger encompass one unified set of books for the corresponding transaction;
wherein the one unified set of books is associated with the transaction table for the corresponding transaction.

5. The system of claim 4, wherein the processor of the server is additionally configured to:
receive a data entry related to the corresponding transaction, wherein the data entry complies with the one other set of accounting objectives but not the default set of accounting objectives, and wherein the data entry necessitates an update to the transaction table and the second digital general ledger; and
when performing the action, if the identified set of accounting objectives is the default set of accounting objectives then performing the action utilizing one or more data entries that comply with the default set of accounting objectives, if available, otherwise utilizing a data entry that complies with the one other set of accounting objectives.
